(19) United States
(12) Patent Application Publication
(10) Pub. No.: US 2025/0121905 A1
(43) Pub. Date: Apr. 17, 2025

(54) FRAME ASSEMBLY FOR AN OFF-ROAD VEHICLE

(71) Applicant: BOMBARDIER RECREATIONAL PRODUCTS INC., Valcourt (CA)

(72) Inventors: Philippe ROUSSEAU, Sherbrooke (CA); Dominic DUMONT, Sherbrooke (CA); Robin BEAUCHEMIN, St-Denis-de-Brompton (CA); Rémi BRETON, Drummondville (CA); Jonathan FORTIER, Lawrenceville (CA); Alexandre VACHON, Sherbrooke (CA)

(73) Assignee: BOMBARDIER RECREATIONAL PRODUCTS INC., Valcourt (CA)

(21) Appl. No.: 18/912,883

(22) Filed: Oct. 11, 2024

Related U.S. Application Data
(60) Provisional application No. 63/543,956, filed on Oct. 13, 2023.

(51) Int. Cl. B62K 5/01; B62J 43/16

(52) U.S. Cl. CPC B62K 5/01; B62J 43/16

(57) ABSTRACT

Electric and hybrid off-road vehicles, accessories and frames therefor are provided. An off-road vehicle comprises a frame assembly, at least one front and rear wheel, at least one electric motor, at least one battery and at least one final drive unit operatively coupled to at least one wheel. The electric motor is operatively coupled to the final drive unit for transferring torque from the electric motor to the wheel. A battery assembly having electric components integrated thereto is provided. A structural battery is configured to provide a structural connection between at least two of a top, bottom, front and rear portions of a frame assembly for an off-road vehicle, and for receiving loads therefrom. Improved drivetrain arrangements provide flexibility in operating an off-road vehicle and improve overall performance. The environmental impact of off-road vehicles is reduced. Weight and complexity of off-road vehicle frames are reduced without affecting stability or safety.

### CROSS REFERENCE TO RELATED APPLICATIONS

The present application claims priority from U.S. Provisional Patent Application Ser. No. 63/543,956 filed on Oct. 13, 2023, the content of which is herein incorporated by reference in its entirety.

### FIELD

The present disclosure relates to off-road vehicles, more precisely to electric and hybrid recreational off-road vehicles.

### BACKGROUND

Off-road vehicles such as all-terrain vehicles (ATVs) are designed to operate in rough, off-road terrains and generally comprise a robust frame mounted on four wheels. Front and rear suspensions are provided between the frame and the wheel for absorbing bumps. An engine is mounted to the frame and is operatively connected to the rear wheels, and in some instances, to the front wheels as well. The front wheels are operatively connected to a steering assembly for steering the ATV, and a straddle seat is mounted to the frame for the operator to sit. Generally, the straddle seat is positioned above the engine such that the rider is located proximal to the longitudinal position of the center of gravity of the ATV, to minimize the impact of the bumps encountered during the operation of the ATV.

Because of the use for which they are designed, ATVs are subject to relatively high bending and torsional forces, which have to be resisted by their frames. Typical ATV frames, sometimes referred to as “space” or “open structure” frames, have been constructed with sufficient strength and rigidity for ATV applications. However, to provide the necessary strength and rigidity, these frames are generally highly complex or use a significant amount of material. Such typical frame configurations tend to be costly to manufacture and sometimes present the disadvantage of being heavy.

Additionally, ATVs are often used for pulling or hauling heavy equipment, camping gear, hunting gear, other farming or forestry equipment or even other all-terrain vehicles. Therefore, a high torque output is often required of ATVs.

Environmental regulatory changes and increasing energy costs make operating an ATV increasingly expensive. An example of providing an electric ATV is presented in United States Patent Application Publication Number 2022/0266908 published on Aug. 25, 2022 and titled “Off-Road Vehicle”, however the multiple drivetrain and energy storage components tend to be bulky and to have an inflexible, predetermined configuration that cannot be adapted to users' needs. Other attempts at providing improved electric vehicles included attempts at reducing electric losses due to wiring. An example is shown in United States Patent Application Publication Number 2022/0407320 published on Dec. 22, 2022 and titled “Battery Pack With Integral Charging Port”, where a charging port is integrated to a battery body. However, such arrangements do not reduce maintenance downtime. Users must still spend time disassembling, disconnecting, reassembling and reconnecting the battery.

Accordingly, there is a need for improved off-road configurations and improved electric off-road vehicle components that alleviate at least some of the above-identified drawbacks.

### SUMMARY

According to a broad aspect, an off-road vehicle comprises a frame assembly comprising a front portion, a middle portion and a rear portion, at least one front wheel rotationally mounted to the front portion of the frame assembly, at least one rear wheel rotationally mounted to the rear portion of the frame assembly, at least one electric motor mounted to at least one of the front portion, the middle portion and the rear portion of the frame assembly, at least one battery assembly electrically coupled to the at least one electric motor for providing electric power to the at least one electric motor, and at least one final drive unit mounted to at least one of the front portion and the rear portion of the frame assembly, the at least one final drive unit being operatively coupled to at least one of the at least one front wheel and at least one of the at least one rear wheel, and the at least one electric motor is operatively coupled to the at least one final drive unit for transferring torque from the electric motor to the at least one of the at least one front wheel or the at least one rear wheel for propelling the same.

In embodiments, the off-road vehicle comprises one rear electric motor mounted to the rear portion of the frame assembly, and a first rear final drive unit mounted to the rear portion of the frame assembly, the first rear final drive unit being operatively coupled to the rear electric motor for transferring torque from the rear electric motor to the at least one rear wheel.

In embodiments, the at least one rear wheel comprises a first pair of rear wheels operatively coupled to the first rear final drive unit.

In embodiments, the at least one rear wheel comprises first and second rear wheels rotationally mounted to the rear portion of the frame assembly, the second rear wheel being positioned rearwardly of the first rear wheel, and the off-road vehicle further comprises a second rear final drive unit mounted to the rear portion of the frame assembly, the second rear final drive unit being positioned rearwardly of the first rear final drive unit, the first rear final drive unit being operatively coupled to the first rear wheel and the second rear final drive unit being operatively coupled to the second rear wheel, and a rearward driveshaft operatively coupling the first rear final drive unit to the second rear final drive unit for simultaneously transferring torque from the rear electric motor to the first and second rear wheels.

In embodiments, the at least one rear wheel comprises a first pair of rear wheels and a second pair of rear wheels rotationally mounted to the rear portion of the frame assembly, the second pair of rear wheels being positioned rearwardly of the first pair of rear wheels, and the off-road vehicle further comprises a second rear final drive unit mounted to the rear portion of the frame assembly, the second rear final drive unit being positioned rearwardly of the first rear final drive unit, the first rear final drive unit being operatively coupled to the first pair of rear wheels and the second rear final drive unit being operatively coupled to the second pair of rear wheels, and a rearward driveshaft operatively coupling the first rear final drive unit to the second rear final drive unit for simultaneously transferring torque from the rear electric motor to the first pair of rear wheels and the second pair of rear wheels.

In embodiments, the off-road vehicle further comprises a front final drive unit mounted to the front portion of the frame assembly and operatively coupled to the at least one front wheel and a forward driveshaft extending from the rear portion to the front final drive unit and operatively coupled to the rear electric motor for simultaneously transferring torque from the rear electric motor to the at least one rear wheel and the at least one front wheel.

In embodiments, the at least one front wheel comprises a pair of front wheels rotationally mounted to the front portion of the frame assembly and the off-road vehicle further comprises a front final drive unit mounted to the front portion of the frame assembly and operatively coupled to the pair of front wheels and a forward driveshaft extending from the rear portion to the front final drive unit and operatively coupled to the rear electric motor for simultaneously transferring torque from the rear electric motor to the at least one rear wheel and to the pair of front wheels.

In embodiments, the off-road vehicle comprises one front electric motor mounted to the front portion of the frame assembly, and a front final drive unit mounted to the front portion of the frame assembly and operatively coupled to the front electric motor for transferring torque from the electric motor to the at least one front wheel.

In embodiments, the at least one front wheel comprises a pair of front wheels operatively coupled to the front final drive unit.

In embodiments, the off-road vehicle comprises one front electric motor mounted to the front portion of the frame assembly, and a front final drive unit mounted to the front portion of the frame assembly and operatively coupled to the front electric motor, for transferring torque from the electric motor to the at least one front wheel, a rear final drive unit mounted to the rear portion of the frame assembly and operatively coupled to the at least one rear wheel, and a first rearward driveshaft extending from the front portion to the rear final drive unit and operatively coupled to the front electric motor for simultaneously transferring torque from the front electric motor to the at least one front wheel and the at least one rear wheel.

In embodiments, the at least one front wheel comprises a pair of front wheels rotationally mounted to the front portion of the frame assembly and the at least one rear wheel comprises a first pair of rear wheels rotationally mounted to the rear portion of the frame assembly and the off-road vehicle further comprises one front electric motor mounted to the front portion of the frame assembly, and a front final drive unit mounted to the front portion of the frame assembly and operatively coupled to the front electric motor, for transferring torque from the electric motor to the pair of front wheels, a first rear final drive unit mounted to the rear portion of the frame assembly and operatively coupled to the pair of rear wheels, and a first rearward driveshaft extending from the front portion to the first rear final drive unit and operatively coupled to the front electric motor for simultaneously transferring torque from the front electric motor to the pair of front wheels and the first pair of rear wheels.

In embodiments, the at least one rear wheel further comprises a second pair of rear wheels rotationally mounted to the rear portion of the frame assembly, the second pair of rear wheels being positioned rearwardly of the first pair of rear wheels and the off-road vehicle further comprises a second rear final drive unit mounted to the rear portion of the frame assembly, the second rear final drive unit being positioned rearwardly of the first rear final drive unit, the first rear final drive unit being operatively coupled to the first pair of rear wheels and the second rear final drive unit being operatively coupled to the second pair of rear wheels, and a second rearward driveshaft operatively coupling the first rear final drive unit to the second rear final drive unit for simultaneously transferring torque from the front electric motor to the pair of front wheels, the first pair of rear wheels and the second pair of rear wheels.

In embodiments, the battery is mounted to the middle portion of the frame assembly.

In embodiments, the off-road vehicle further comprises a skid plate and a straddle seat mounted to the frame assembly, the battery assembly being mounted to the frame assembly between the skid plate and the straddle seat.

In embodiments, the off-road vehicle has a longitudinal axis extending between a front end of the vehicle and a rear end thereof, and the at least one electric motor comprises an output shaft, the output shaft extending parallel to the longitudinal axis of the off-road vehicle or perpendicular thereto.

In embodiments, the off-road vehicle further comprises at least one transmission operatively coupled to one of the at least one final drive unit or the at least one electric motor. In embodiments, the at least one transmission allows a range of rotation speeds to be transferred to the at least one wheel during operation of the at least one electric motor. In embodiments, the at least one transmission is a Continuous Variable Transmission. In embodiments the rotation speeds comprise at least one of a neutral speed, a high speed and a low speed. In embodiments, the at least one transmission allows a range of torque output values to be transferred to the at least one wheel during operation of the at least one electric motor.

In embodiments, the off-road vehicle further comprises at least one power take-off (PTO) shaft operatively coupled to at least one of the at least one transmission and the at least one final drive unit.

In embodiments, the off-road vehicle further comprises a cooling circuit, the cooling circuit being operatively coupled to at least one of the at least one electric motor for cooling the same.

In embodiments, the off-road vehicle further comprises at least one gearbox operatively coupled to at least one of the at least one electric motor, the at least one final drive unit, the at least one transmission, and the at least one PTO shaft.

In embodiments, the at least one electric motor is mounted to at least one of the front portion, the middle portion and the rear portion of the frame assembly via at least one mounting point. In embodiments, the at least one mounting point comprises a rigid mounting point or a flexible mounting point.

In embodiments, the at least one front wheel comprises a pair of front wheels and the at least one rear wheel comprises a first pair of rear wheels and a second pair of rear wheels rotationally mounted to the rear portion of the frame assembly, the second pair of rear wheels being positioned rearwardly of the first pair of rear wheels, and the off-road vehicle further comprises a front final drive unit mounted to the front portion of the frame assembly and operatively coupled to the pair of front wheels, a front electric motor mounted to the front portion of the frame assembly and operatively coupled to the front final drive unit for transferring torque from the front electric motor to the pair of front wheels, a first rear final drive unit mounted to the rear portion of the frame assembly and operatively coupled to the first pair of rear wheels, a first rear electric motor operatively coupled to the first rear final drive unit for transferring torque from the first rear electric motor to the first pair of rear wheels, a second rear final drive unit mounted to the rear portion of the frame assembly and operatively coupled to the second pair of rear wheels, and a second rear electric motor operatively coupled to the second rear final drive unit for transferring torque from the second rear electric motor to the second pair of rear wheels.

In embodiments, the off-road vehicle comprises a transfer case operatively coupled to at least one of the at least one electric motor, at least one final drive unit, at least one transmission and at least one gearbox, the transfer case being configured for allowing the switching of the off-road vehicle between two or more of a plurality of drive modes. In embodiments, the plurality of drive modes includes at least one of two-wheel drive and 4-wheel drive.

In embodiments, the off-road vehicle comprises two or more electric motors, and any one of the two or more electric motors can be controlled independently.

According to another broad aspect, a battery assembly for an off-road vehicle comprises a housing having an exterior side and an interior side, the interior side defining a chamber, a battery pack received in the chamber of the housing, at least one electrical connection extending from the battery pack towards the exterior side of the housing, the at least one electrical connection comprising an interior end electrically connected to the battery pack and an exterior end located on the exterior side of the housing, and at least one of an inverter electrically connected to at least one phase cable, a charger, a charging port, a brake fluid reservoir, a coolant heater, a coolant pump, and a high-voltage cable secured to the exterior side of the housing, the at least one inverter, charger, charging port and high-voltage cable being electrically connected to the exterior end of the at least one electrical connection to connect the battery pack.

In embodiments, the battery assembly further comprises at least one mounting bracket provided on the exterior side of the housing, the at least one mounting bracket being adapted to secure the at least one inverter, charger, charging port, high-voltage cable and phase cable.

In embodiments, the battery assembly can be preassembled prior to installation in the off-road vehicle.

In embodiments, the battery assembly further comprises a cold plate located adjacent to at least a portion of the battery pack for cooling the same.

In embodiments, an off-road vehicle comprises a battery assembly as described above.

In embodiments, the off-road vehicle comprises a frame assembly, at least one front wheel, at least one rear wheel, and at least one electric motor mounted to the frame assembly and operatively coupled to at least one of the at least one front wheel and the at least one rear wheel, the frame assembly defining a battery compartment for receiving therein the battery assembly, and the phase cable being configured to be electrically connected to the electric motor.

In embodiments, the off-road vehicle is a straddle seat off-road vehicle.

In embodiments, the at least one front wheel has a front wheel axle, the at least one rear wheel has a rear wheel axle, and the battery assembly is located below the straddle seat and between the front and rear wheel axles.

In embodiments, the battery assembly is a structural battery assembly

According to another broad aspect, a method for assembling an off-road vehicle comprising a frame assembly, at least one front wheel, at least one rear wheel, and an electric motor mounted to the frame assembly and operatively coupled to at least one of the at least one front wheel and the at least one rear wheel, the method comprises providing the frame assembly, providing a battery assembly as described above, installing the battery to the frame assembly, and connecting the phase cable to the electric motor.

In embodiments, the method further comprises installing the at least one front wheel and the at least one rear wheel.

In embodiments, the steps of installing the at least one front wheel and the at least one rear wheel are carried out before or after installing the battery to the frame assembly.

According to another broad aspect, a frame assembly for an off-road vehicle having at least one front wheel and at least one rear wheel comprises a bottom section, a top section, a front portion for supporting the at least one front wheel, a rear portion for supporting the at least one rear wheel, and a middle portion connecting the front portion and the rear portion, the middle portion comprising a structural battery assembly, the structural battery assembly being configured for receiving loads from at least one of the front portion, the rear portion and the middle portion.

In embodiments, the battery assembly provides a connection between the front portion and the rear portion of the frame assembly.

In embodiments, the frame assembly further comprises at least one front attachment member extending from the front portion towards the rear portion and connecting a front end of the structural battery assembly, and at least one rear attachment member extending from the rear portion of the frame assembly towards the front portion and connecting a rear end of the structural battery assembly.

In embodiments, the at least one front attachment member is part of the front portion. In embodiments, the at least one front attachment member is part of the middle portion. In embodiments, the at least one rear attachment member is part of the rear portion. In embodiments, the at least one rear attachment member is part of the middle portion. In embodiments, the frame assembly comprises a front end and a rear end and a longitudinal axis between the front end and the rear end, and at least one of the at least one front attachment member and the at least one rear attachment member extends substantially along the longitudinal axis. In embodiments, the at least one front and rear attachment members are located in the top section of the frame assembly. In embodiments, the at least one front and rear attachment members are located in the bottom section of the frame assembly.

In embodiments, the frame assembly further comprises at least one longitudinal member for directly connecting the front portion of the frame assembly to the rear portion. In embodiments, the at least one longitudinal member extends below the battery assembly to connect the front portion of the frame assembly to the rear portion. In embodiments, the at least one longitudinal member extends above the battery assembly to connect the front portion of the frame assembly to the rear portion.

In embodiments, the structural battery assembly provides a connection between the bottom frame section and the top frame section.

In embodiments, the front portion of the frame assembly comprises at least one front vertical frame member extending between the bottom section and the top section, the battery assembly being provided on the at least one front vertical frame member to provide a connection between the bottom section and the top section.

In embodiments, the rear portion of the frame assembly comprises at least one rear vertical frame member extending between the bottom section and the top section, the battery assembly being provided on the at least one rear vertical frame member to provide connection between the bottom section and the top section.

In embodiments, the frame assembly further comprises a skid plate mounted to at least one of the front portion, the middle portion and the rear portion, and the battery assembly is configured for receiving loads from the skid plate. In embodiments, the battery assembly is located above the skid plate.

In embodiments, the frame assembly further comprises a rack mounted to at least one of the front portion, the middle portion and the rear portion, and the battery is configured for receiving loads from the rack. In embodiments, the rack comprises a cargo storage rack.

In embodiments, the frame assembly further comprises at least one seat mounting bracket provided on at least one of the middle portion and the rear portion for mounting a seat to the frame assembly, and the battery is configured for receiving loads from the seat mounting bracket. In embodiments, the seat is a straddle seat.

In embodiments, the battery assembly comprises a battery housing, the battery housing being configured for receiving at least of portion of the loads from the front portion, the rear portion and the middle portion. In embodiments, the battery assembly further comprises a battery pack housed in the battery housing.

In embodiments, loads from the front section comprise loads received from at least one of the at least front wheel, a front suspension and an impact on the front portion of the frame assembly. In embodiments, loads from the rear section comprise loads received from at least one of the at least one rear wheel, a rear suspension and an impact on the rear portion of the frame assembly.

In embodiments, the structural battery assembly is configured for receiving loads from at least two of the front section, the middle section, the rear section, the skid plate, the rack and the at least one seat mounting bracket.

In embodiments, the middle portion is comprised substantially entirely of the battery assembly.

In embodiments, an off-road vehicle comprises a frame assembly as described above. In embodiments, the off-road vehicle comprises an all-electric off-road vehicle or a hybrid electric off-road vehicle.

In embodiments, the off-road vehicle further comprises an electric motor electrically connected to the battery assembly and a transmission assembly operatively coupling the electric motor to at least one of the at least one front wheel and the at least one rear wheel, the transmission assembly comprising a driveshaft.

In embodiments, the battery assembly is configured to allow the passage of the driveshaft towards the front portion or the rear portion to connect to the at least one front wheel or the at least one rear wheel. In embodiments, the battery assembly is configured to allow the passage of the driveshaft towards the front portion or the rear portion above the battery assembly. In embodiments, the battery assembly is configured to allow the passage of the driveshaft towards the front portion or the rear portion below the battery assembly.

In embodiments, the battery assembly comprises a channel defined therein, the channel allowing the passage of the driveshaft through the battery assembly, towards the front portion or the rear portion.

According to a broad aspect, a method for assembling an off-road vehicle comprising a frame assembly, at least one front wheel, at least one rear wheel, and an electric motor mounted to the frame assembly and operatively coupled to at least one of the at least one front wheel and the at least one rear wheel comprises providing the frame assembly as described above, providing a structural battery assembly, installing the structural battery assembly to the frame assembly and connecting the structural battery assembly and the electric motor using a phase cable.

In embodiments, the method further comprises installing the at least one front wheel and the at least one rear wheel. In embodiments, the steps of installing the at least one front wheel and the at least one rear wheel are carried out before or after installing the battery to the frame assembly.

### BRIEF DESCRIPTION OF THE DRAWINGS

FIG. 1 is a rear, right perspective view of an off-road vehicle in accordance with one embodiment.

FIG. 2 is a rear, left perspective view of the off-road vehicle of FIG. 1.

FIG. 3 is a front right perspective view of the off-road vehicle of FIG. 1.

FIG. 4 is a front left perspective view of the off-road vehicle of FIG. 1.

FIG. 5 is a right side view of the off-road vehicle of FIG. 1.

FIG. 6 is a left side view of the off-road vehicle of FIG. 1.

FIG. 7 is a rear view of the off-road vehicle of FIG. 1.

FIG. 8 is a front view of the off-road vehicle of FIG. 1.

FIG. 9 is a rear right perspective view of a frame for an off-road vehicle in accordance with one embodiment with a steering assembly, with a seat and front and rear suspensions mounted thereto.

FIG. 10 is a rear left perspective view of the frame, seat and front and rear suspensions of FIG. 9.

FIG. 11 is a front right perspective view of the frame, seat and front and rear suspensions of FIG. 9.

FIG. 12 is a front left perspective view of the frame, seat and front and rear suspensions of FIG. 9.

FIG. 13 is a right side view of the frame, seat and front and rear suspensions of FIG. 9.

FIG. 14 is a left side view of the frame, seat and front and rear suspensions of FIG. 9.

FIG. 15 is a rear view of the frame, seat and front and rear suspensions of FIG. 9.

FIG. 16 is a front view of the frame, seat and front and rear suspensions of FIG. 9.

FIG. 17 is a front right perspective view of the frame, seat and front and rear suspensions of FIG. 9 and a skid plate mounted thereto, in accordance with one embodiment.

FIG. 18 is a front right perspective view of the frame, seat, skid plate and front and rear suspensions of FIG. 17 with wheels mounted thereto, in accordance with one embodiment.

FIG. 19 is a front right perspective view of the frame, seat, skid plate, front and rear suspensions and wheels of FIG. 18 with a driveshaft installed therein, in accordance with one embodiment.

FIG. 20 is a front right perspective view of the frame, seat, skid plate, front and rear suspensions and wheels of FIG. 19 with the seat removed for showing a seat mounting bracket, in accordance with one embodiment.

FIG. 21 is a rear right perspective view of a frame, steering assembly, drivetrain elements, suspensions and seat for an all-terrain vehicle in accordance with one embodiment.

FIG. 22 is a rear left perspective view of the frame, steering assembly, drivetrain elements, suspensions and seat of FIG. 21.

FIG. 23 is a front right perspective view of the frame, steering assembly, drivetrain elements, suspensions and seat of FIG. 21.

FIG. 24 is a front left perspective view of the frame, steering assembly, drivetrain elements, suspensions and seat of FIG. 21.

FIG. 25 is a right side view of the frame, steering assembly, drivetrain elements, suspensions and seat of FIG. 21.

FIG. 26 is a left side view of the frame, steering assembly, drivetrain elements, suspensions and seat of FIG. 21.

FIG. 27 is a rear view of the frame, steering assembly, drivetrain elements, suspensions and seat of FIG. 21.

FIG. 28 is a front view of the frame, steering assembly, drivetrain elements, suspensions and seat of FIG. 21.

FIG. 29 is a bottom view of the frame, steering assembly, drivetrain elements, suspensions and seat of FIG. 21.

FIG. 30 is a top view of the frame, steering assembly, drivetrain elements, suspensions and seat of FIG. 21.

FIG. 31 is another rear right perspective view of the frame, steering assembly, drivetrain elements, suspensions and seat of FIG. 21.

FIG. 32 is a rear right perspective view of the frame, steering assembly, drivetrain elements, suspensions and seat of FIG. 21 having a different rear final drive unit comprising a Power Take-Off (PTO) shaft mounted thereto.

FIG. 33 is a rear right perspective view of a frame and a 2-motor 4×4 drivetrain arrangement for an off-road vehicle in accordance with one embodiment.

FIG. 34 is a rear right perspective view of the frame and drivetrain arrangement of FIG. 33 with wheel coupling assemblies coupled to the final drive units.

FIG. 35 is a rear right perspective view of a frame and a 6-wheel drivetrain arrangement for an off-road vehicle in accordance with one embodiment.

FIG. 36 is another embodiment of the frame and 6-wheel drivetrain arrangement of FIG. 35 having two motors mounted thereto.

FIG. 37 is another embodiment of the frame and 6-wheel drivetrain arrangement of FIG. 35 having three motors mounted thereto.

FIG. 38 is a section view of a frame, battery assembly and driveshaft for an off-road vehicle where the battery defines a channel for allowing the passage of a driveshaft between a front portion and a rear portion of the frame.

FIG. 39 is a rear left perspective view of a battery assembly in accordance with one embodiment.

FIG. 40 is a right side elevation view of the battery assembly of FIG. 38.

FIG. 41 is a left side elevation view of the battery assembly of FIG. 38.

FIG. 42 is a rear elevation view of the battery assembly of FIG. 38.

FIG. 43 is a front elevation view of the battery assembly of FIG. 38.

FIG. 44 is a front left perspective view of the battery assembly of FIG. 38.

FIG. 45 is a left side lower view of the battery assembly of FIG. 38.

FIG. 46 is a right side lower view of the battery assembly of FIG. 38.

FIG. 47 is a rear lower view of the battery assembly of FIG. 38.

FIG. 48 is a partially exploded rear right perspective view of the battery assembly of FIG. 38.

FIG. 49 is rear left perspective view of the battery assembly of FIG. 48.

FIG. 50 is a front right perspective view of the battery assembly of FIG. 48.

FIG. 51 is the view of the battery assembly of FIG. 50 from a lower elevation.

FIG. 52 is a partially exploded right elevation view of the battery assembly of FIG. 51.

FIG. 53 is an exploded left side view of the battery assembly of FIG. 51.

FIG. 54 is an exploded left elevation view of the battery assembly of FIG. 51.

FIG. 55 is an exploded front elevation view of the battery assembly of FIG. 51.

FIG. 56 is an exploded rear elevation view of the battery assembly of FIG. 51.

FIG. 57 is an exploded right side view of the battery assembly of FIG. 51, showing a battery pack.

FIG. 58 is a rear left perspective view of the battery assembly of FIG. 57.

FIG. 59 is a schematic diagram showing a method of assembling an electric or hybrid off-road vehicle in accordance with one embodiment.

FIG. 60 is rear right perspective view of a frame for an off-road vehicle comprising a vertical structural battery assembly in accordance with one embodiment.

FIG. 61 is a right side view of a frame for an off-road vehicle comprising a horizontal structural battery assembly in accordance with one embodiment.

FIG. 62 is a rear right perspective view of a frame for an off-road vehicle comprising a vertical structural battery assembly in accordance with one embodiment.

FIG. 63 is a rear right perspective view of a frame for an off-road vehicle comprising a vertical structural battery assembly in accordance with one embodiment.

FIG. 64 is a front perspective view of a battery assembly in accordance with another embodiment.

FIG. 65 is a rear perspective view of the battery assembly of FIG. 64.

### DETAILED DESCRIPTION

### Off-Road Vehicle

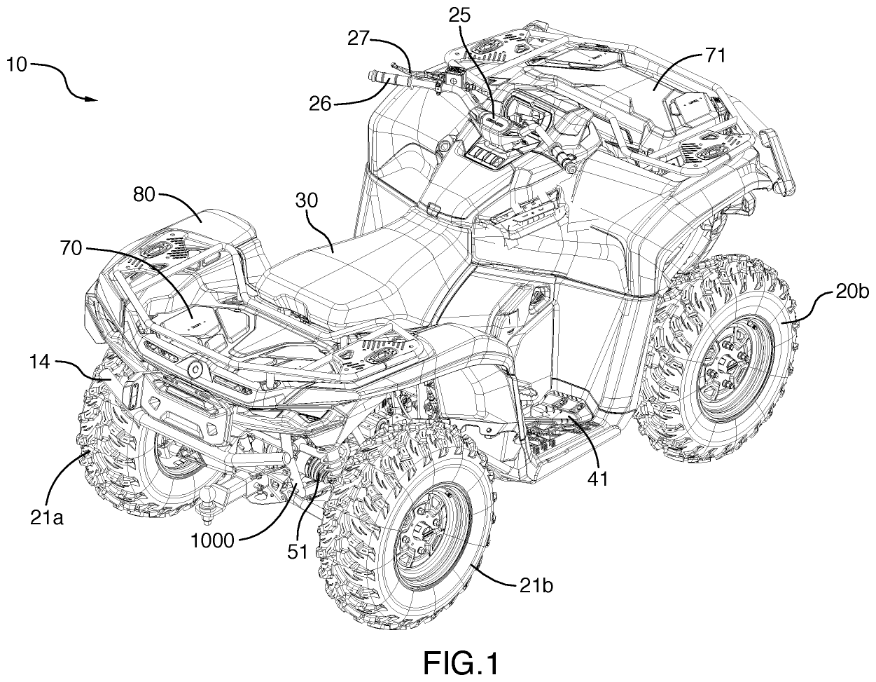

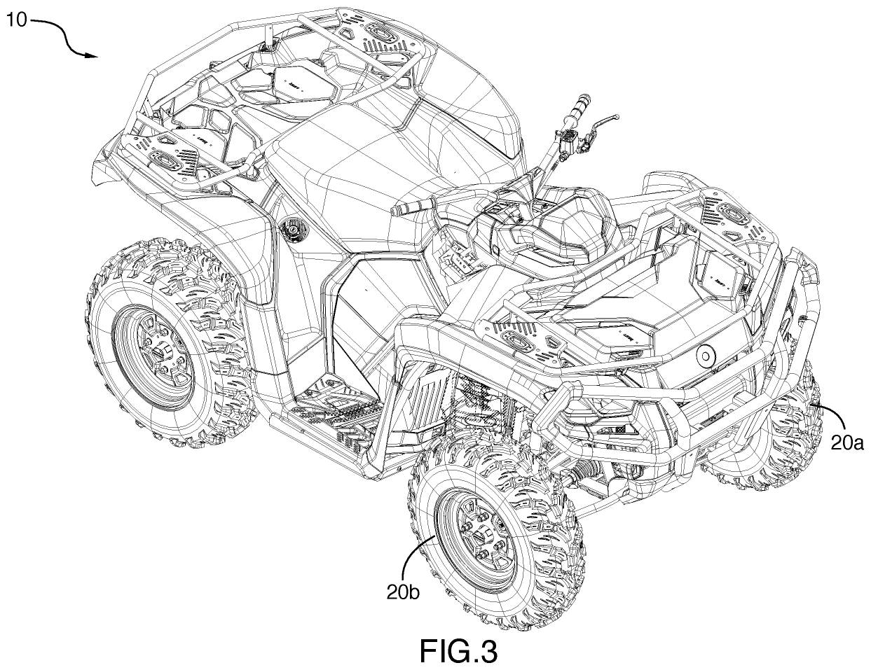

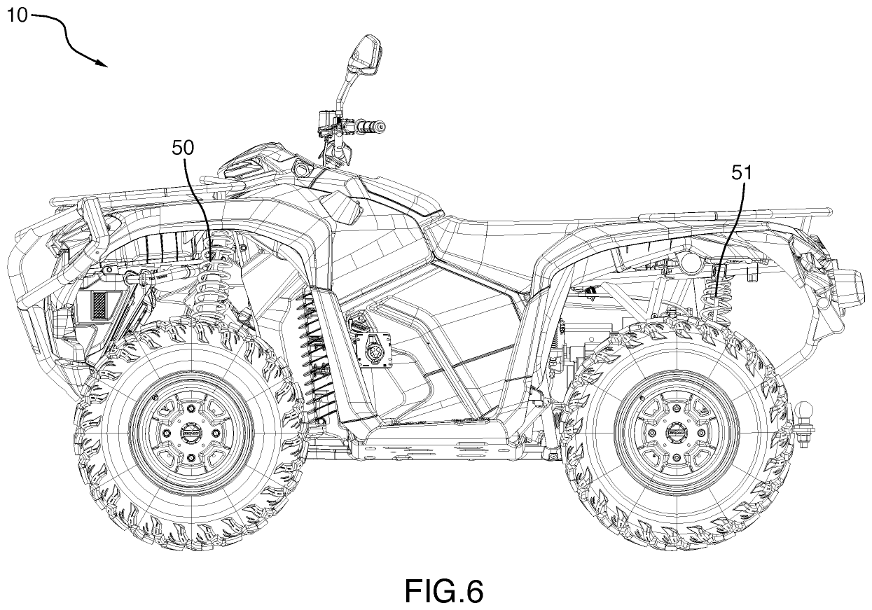

According to a broad aspect, the present disclosure provides an off-road electric or hybrid vehicle. With reference to FIGS. 1 to 8, an exemplary off-road electric or hybrid vehicle 10 is shown in accordance with an embodiment of the present disclosure. In the illustrated embodiment, the off-road vehicle 10 is an all-terrain vehicle (ATV) configured for use by at least one user while straddling at least one portion of the off-road vehicle 10. In illustrative and non-limiting embodiments, the off-road vehicle 10 may be substantially similar, with the appropriate adaptations, to an all-terrain vehicle described in International Patent Application Publication Number WO/2024/171134, published on Aug. 22, 2024 and titled “Frame for an all-terrain vehicle and all-terrain vehicle comprising the same”, the content of which is incorporated herein by reference.

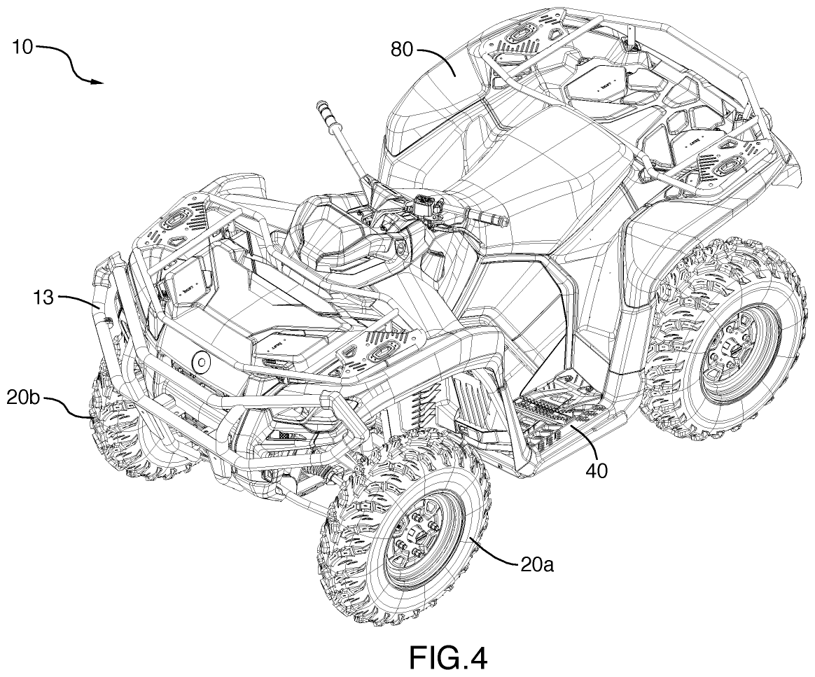

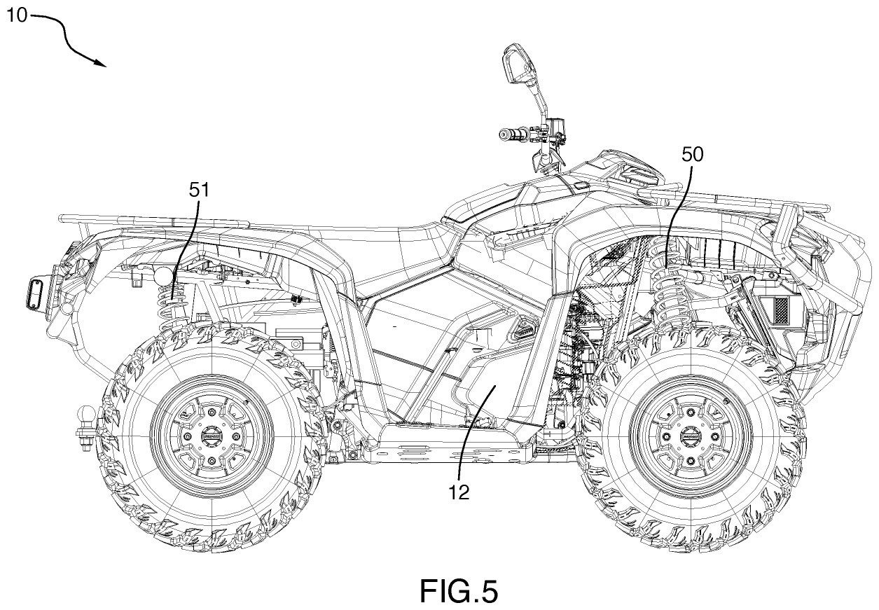

The off-road vehicle 10 comprises a frame assembly 1000, an electric motor (not shown in FIGS. 1 to 8), a front bumper assembly 13 (see FIG. 4), a rear bumper assembly 14 (see FIG. 1), as well as a pair of front wheels 20a, 20b and a pair of rear wheels 21a, 21b mounted to the frame assembly 1000 and operatively coupled to the electric motor. The front wheels 20a, 20b are mounted to the frame assembly 1000 via a front suspension 50 (see FIG. 5). The rear wheels 21a, 21b are mounted to the frame assembly 1000 via a rear suspension 51 (see FIG. 5).

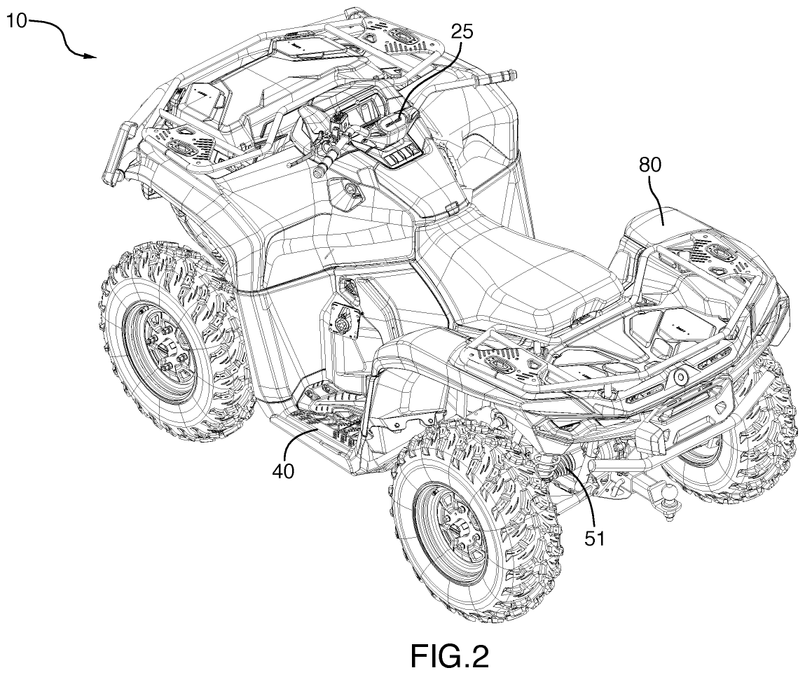

The off-road vehicle 10 also comprises a steering assembly 25 mounted to the frame assembly 1000 and operatively connected to the front wheels 20a, 20b of the off-road vehicle 10 for allowing a user to steer the off-road vehicle 10, as well as a straddle seat 30 and left and right footrests 40, 41 (see FIGS. 1 and 2) for allowing the user to sit on the off-road vehicle 10 and to rest their feet. Provided on the steering assembly 25 are controls (e.g., as seen on FIG. 1, throttle control 26 and brake lever 27). In the illustrated embodiment, the off-road vehicle 10 comprises front and rear storage compartments 70 and 71 for storing and/or transporting objects, as well as fairings 80 for protecting the user, the internal components of the off-road vehicle 10, the motor, the frame assembly 1000 and/or other components.

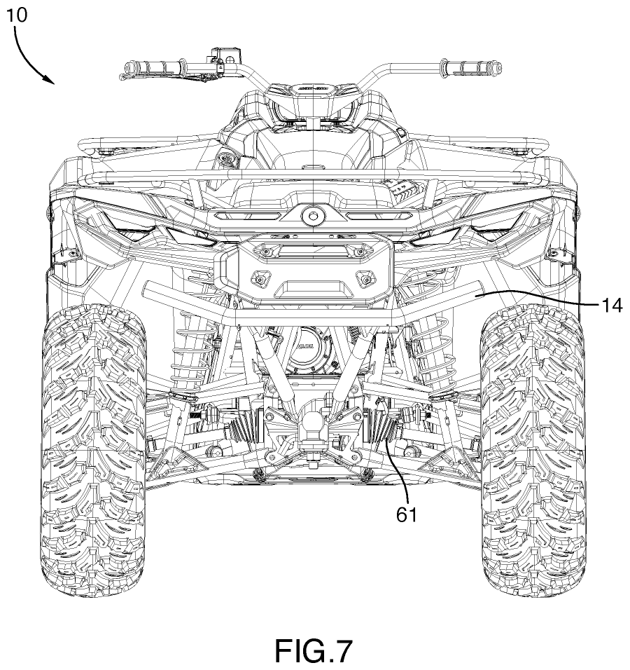

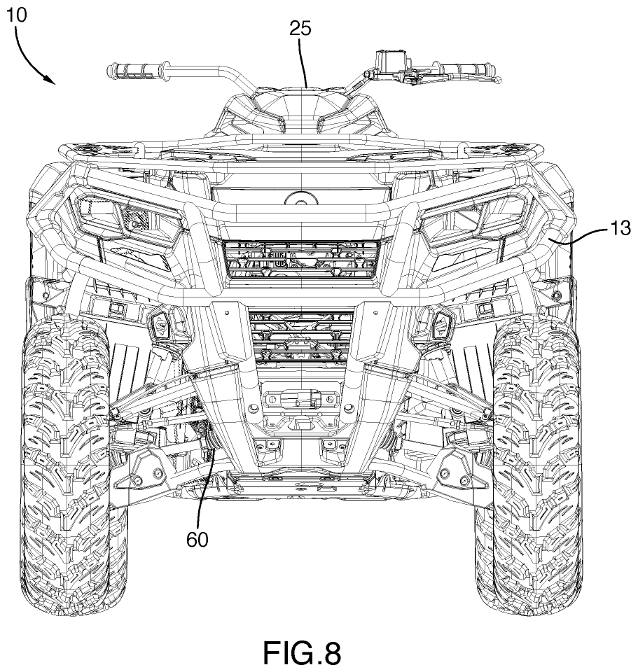

As it will be described in greater details below, the front and/or the rear wheels 20a, 20b, 21a, 21b may be operatively connected to the one or more motors via a front transmission 60 (shown in FIG. 8) and/or a rear transmission 61 (shown in FIG. 7). For example, the off-road vehicle 10 may comprise a plurality of electric motors, and may further comprise an engine when in a hybrid embodiment. Alternatively, the off-road vehicle 10 may comprise two electric motors, each one of the two electric motors being operatively connected to one of the pairs of front wheels and rear wheels. Still alternatively, the off-road vehicle 10 may comprise more than two electric motors, for example four electric motors, each one of the four electric motors being operatively connected to one of the wheels 20a, 20b, 21a, 21b, thus reducing the need for transmission means. Accordingly, it is understood that, in some embodiments, the off-road vehicle 10 may not comprise a transmission.

While FIGS. 1 to 8 show the front wheels 20a, 20b and the rear wheels 21a, 21b mounted to the frame assembly 1000 by means of front and rear suspensions 50, 51, it is understood that other configurations for operatively mounting the front wheels and the rear wheels and for operatively connecting the front wheels and the rear wheels to the electric motor are possible.

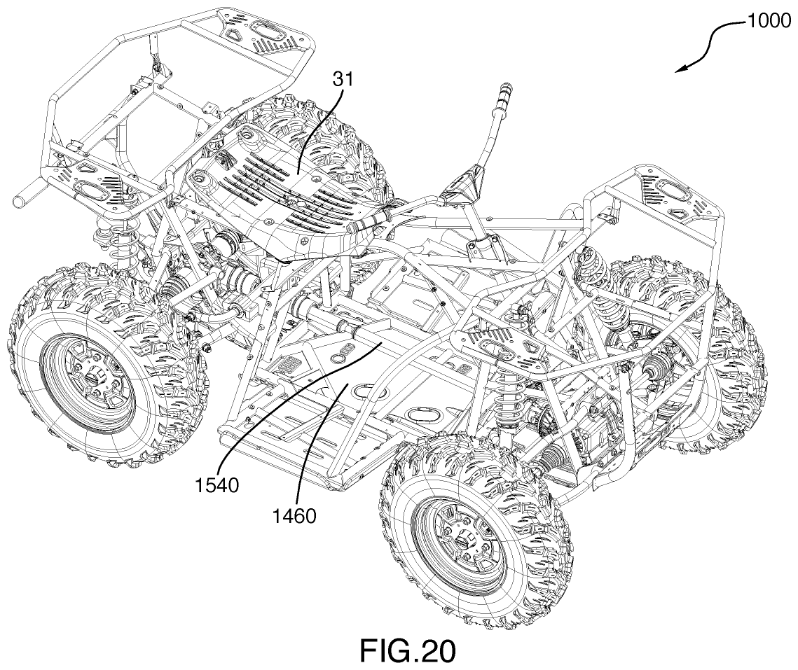

As shown in FIG. 20, the straddle seat 30 is mounted onto the frame assembly 1000 by means of a seat mounting bracket 31. The seat mounting bracket 31 may be secured to the frame assembly 1000 by any acceptable means, including brackets, screws, fasteners and other means.

The off-road vehicle 10 as shown in the illustrated embodiments is configured for single-user use and comprises a straddle seat 30 situated for seating a user substantially above the middle portion of the off-road vehicle 10. The off-road vehicle 10 may be configured for two-user use, and comprise a straddle seat for seating a user substantially above the middle portion and a second straddle seat for seating a second user above at least a portion of the rear portion of the off-road vehicle 10. Other seating configurations are possible. Adaptations of the principles disclosed herein to vehicles comprising other wheel configurations, including but not limited to two-wheeled and three-wheeled vehicles, and/or or to vehicles comprising different means of transmitting torque, such as but not limited to a track on a snowmobile, will be apparent to the skilled person.

### Frame for an Electric or Hybrid Off-Road Vehicle

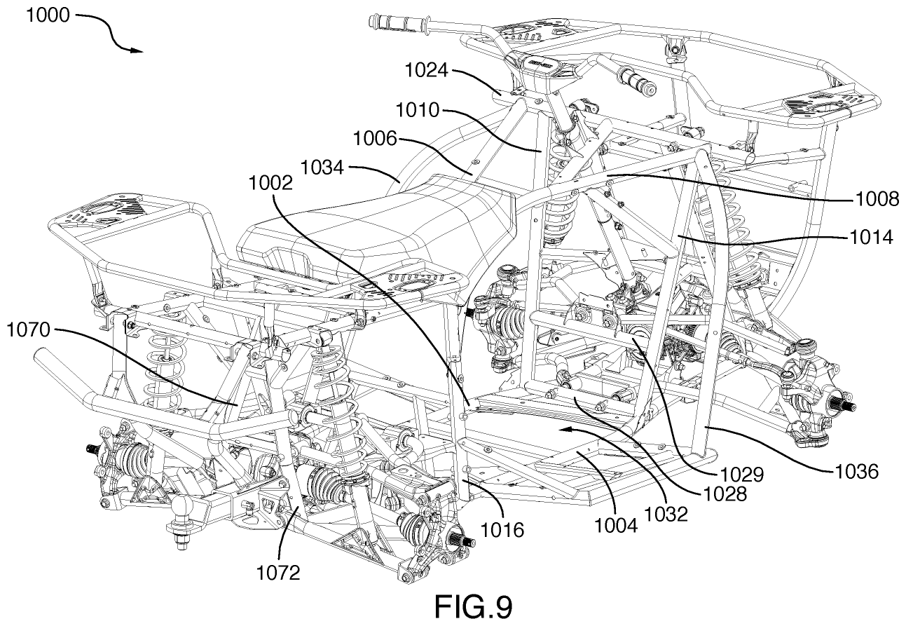

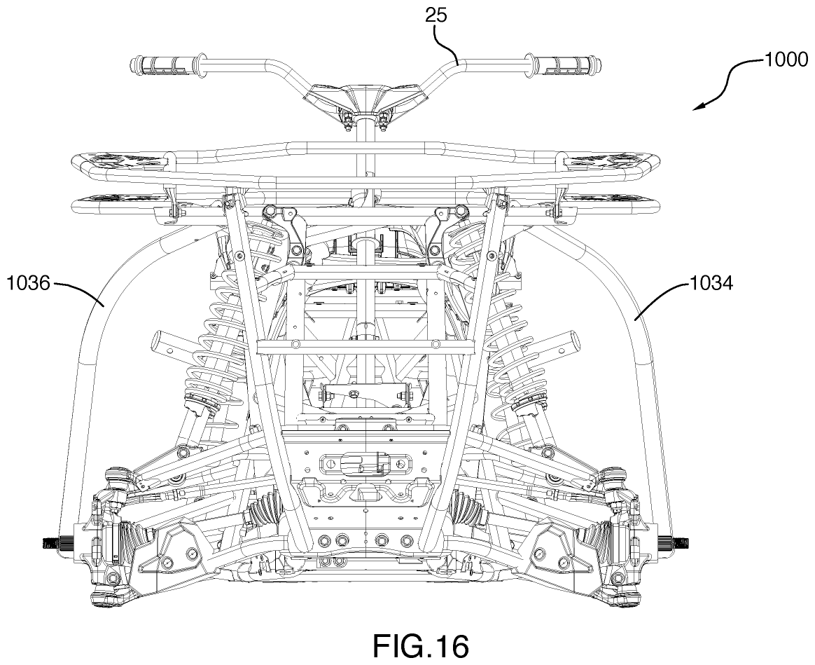

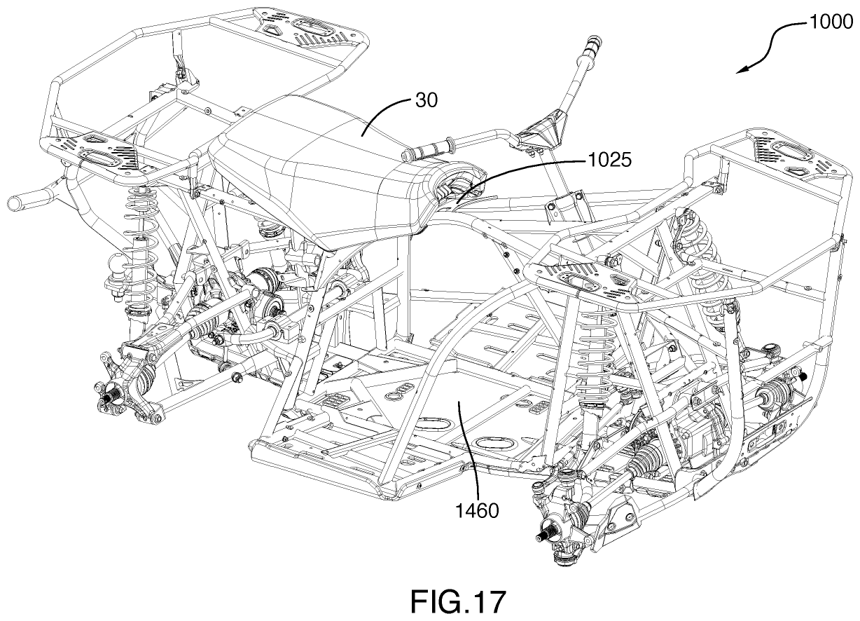

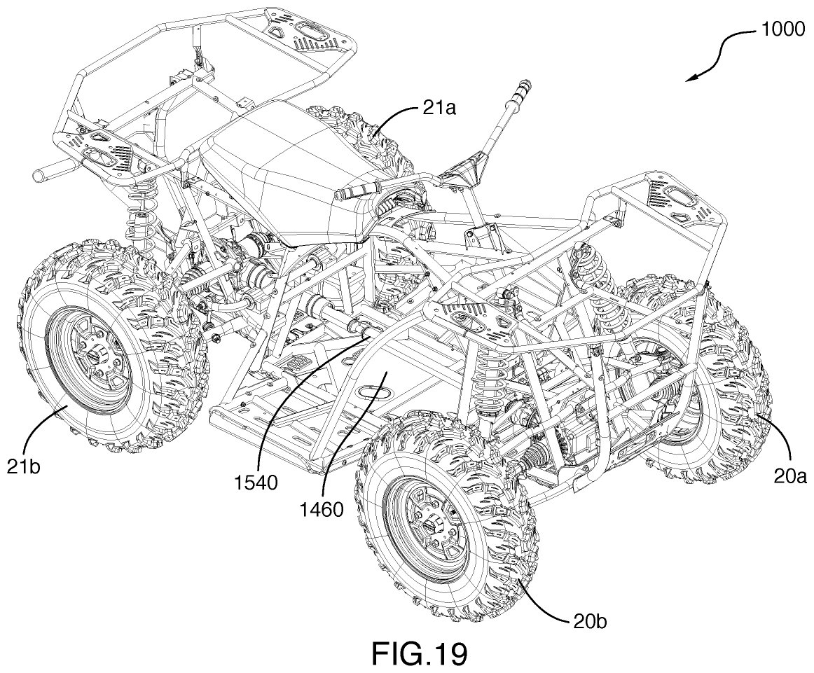

Turning now to FIGS. 9 to 20, 29 and 30, the frame assembly 1000 for use with the off-road vehicle 10 will now be described in accordance with an embodiment. In this embodiment shown in FIGS. 9 to 20, the frame assembly 1000 includes a pair of longitudinally extending, left and right lower tubes 1002, 1004 defining the lower portion of the frame assembly, as well as a left upper tube 1006 and a right upper tube 1008. For the purpose of describing this and other embodiments, the longitudinally extending left and right lower tubes 1002, 1004 and the longitudinally extending left and right upper tubes 1006, 1008 will sometimes be referred to as “bottom longitudinal members” 1002, 1004 or “top longitudinal members” 1006, 1008, being understood that the terms “lower tubes” and “upper tubes” are used interchangeably with “longitudinal members” to designate the same corresponding structures identified with the same reference numerals.

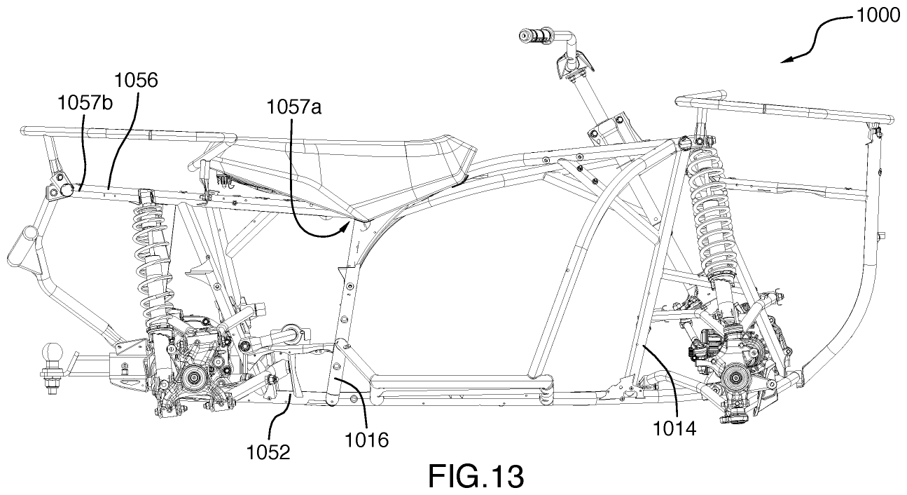

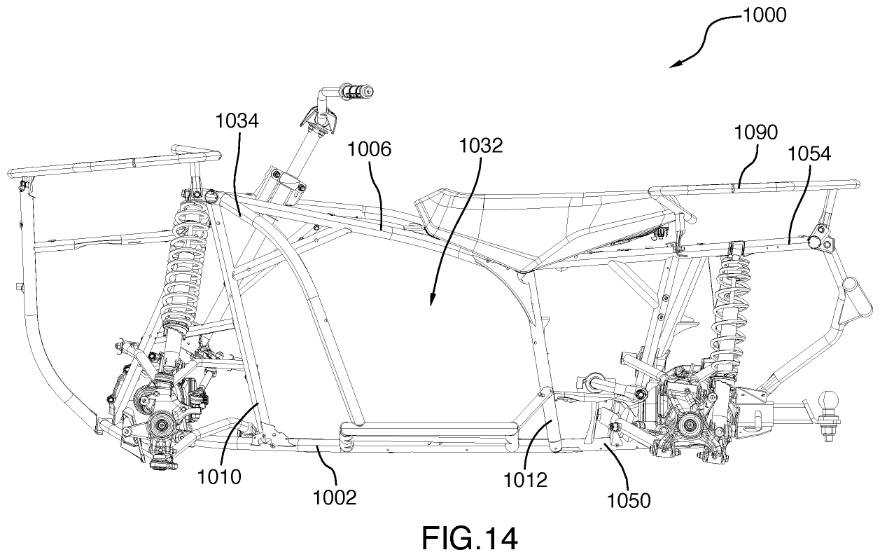

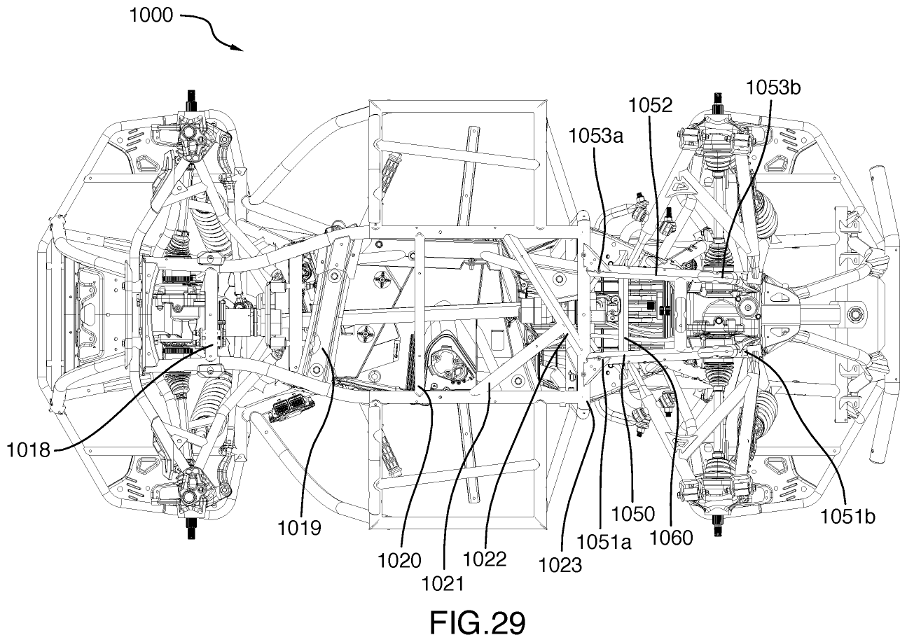

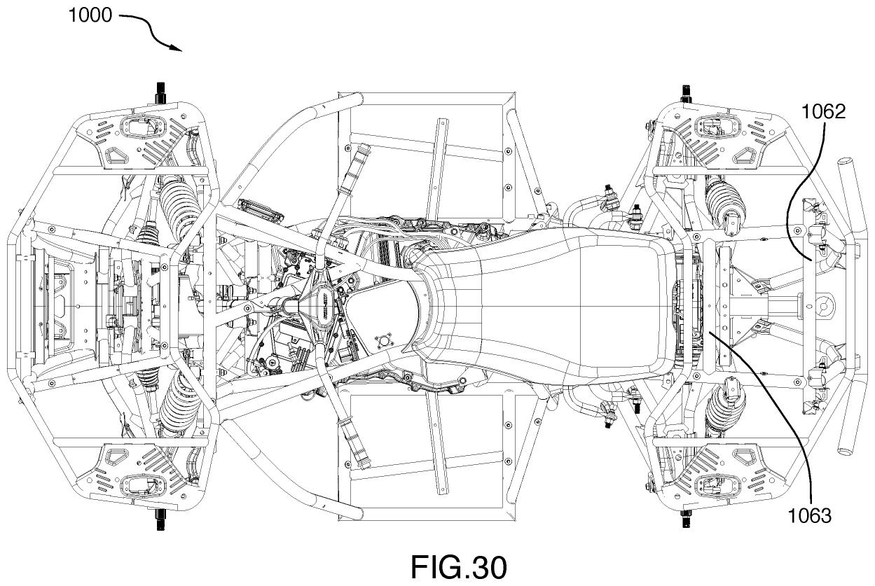

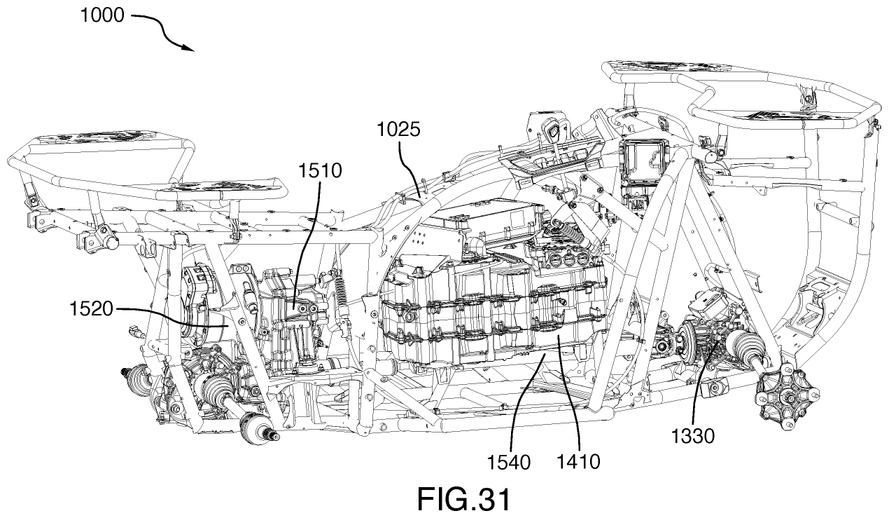

As best shown in FIG. 13, connecting the right lower tube 1004 and the right upper tube 1008 are front and rear right upwardly extending tubes 1014, 1016. Likewise, and as best shown in FIG. 14, connecting the left lower tube 1002 and the left upper tube 1006, are front and rear, left upwardly extending tubes 1010, 1012. Extending between the lower tubes 1002 and 1004 is a plurality of lower cross-members 1018-1023 (best shown in FIG. 29). One or more of the lower cross-members 1018-1023 may extend from the left or right lower tubes 1002 and 1004 at an angle other than a right angle. Two or more cross-members 1018-1023 may intersect each other and/or extend between each other. In the depicted embodiment on FIG. 29, cross-member 1022 extends between the right bottom tube 1004 and cross-member 1023, and bottom cross-member 1021 extends between left lower tube 1002 and cross-member 1022. One or more of the bottom cross-members 1018-1023 may be a stamped sheet of metal. In one embodiment depicted in FIG. 29, bottom cross-member 1019 is made of a sheet of metal. As best shown in FIG. 30, upper tubes 1006, 1008 are connected by upper cross-members 1024 and 1025. While cross-member 1024 of frame assembly 1000 is a tubular member or tube extending generally perpendicular to the longitudinal axis of the off-road vehicle 10, cross-member 1025 of frame 1000 has a slightly different configuration. More specifically, cross-member 1024 is a tubular member extending along a transverse axis (i.e., generally perpendicular to the longitudinal axis of the ATV) while cross-member 1025 is made of a stamped sheet of metal (also shown in FIG. 31). As will be appreciated, the configuration of cross-members 1024-1025 can vary without departing from the scope of this embodiment, where some of all of them could all be made of tubular members or stamped sheets of metal, and could adopt different shapes or different angles relative to the longitudinal or transverse axis of the off-road vehicle 10. Extending between cross-member 1024 and right upper tube 1008 is a tube 1026 (see FIG. 9), configured for attaching the steering column thereto, as it will become apparent below.

Returning to FIG. 9, the front upwardly extending tubes 1010 and 1014 are connected to one another via cross-members 1028-1029. Together, lower tubes 1002, 1004, upper tubes 1006, 1008, front and rear upwardly extending tubes 1010, 1012, 1014, 1016 and cross-members 1018-1023, 1024-1025 and 1028-1029 define a compartment 1032 (see FIGS. 9 to 11) for receiving components of the off-road vehicle 10 including but not limited to one or more batteries, one or more transmissions, one or more gearboxes, one or more mounting assemblies, one or more driveshafts, one or more drivetrain components, one or more airboxes, one or more storage compartments, one or more toolboxes, one or more differentials, one or more drive assemblies and/or one or more final drive units as it will be described in greater detail below.

The right upper tube 1008 extends from a right top proximal end portion through a middle portion to a right top distal end portion. The left upper tube 1006 extends from a left top proximal end portion through a middle portion to a left top distal end portion. The left footrest subframe 1034 extends outwardly sidewardly from the left end portion of the front top cross-member 1024 or from the left top distal end portion of the left upper tube and downwardly to a left bottom end portion. The components of the frame assembly 1000 described above may define one or more compartments adapted for receiving differently sized components of the off-road vehicle 10 therein.

The components of the frame assembly 1000 described above may be connected to or secured to each other by any acceptable connection means. For example, the connection means may be one or more brackets for holding two or more tubes in place. Some components may be welded to each other, secured by screws and/or rivets, and/or mechanically engaging each other to prevent separation.

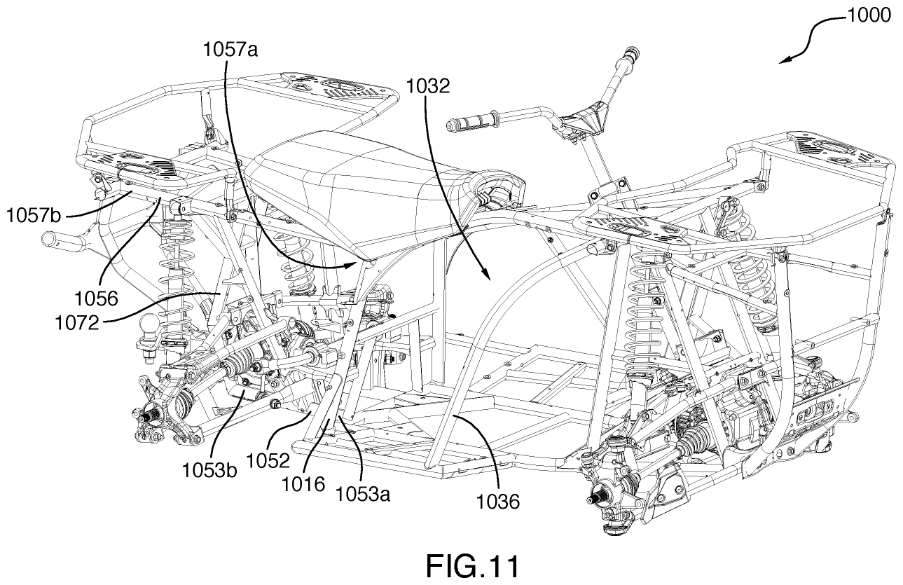

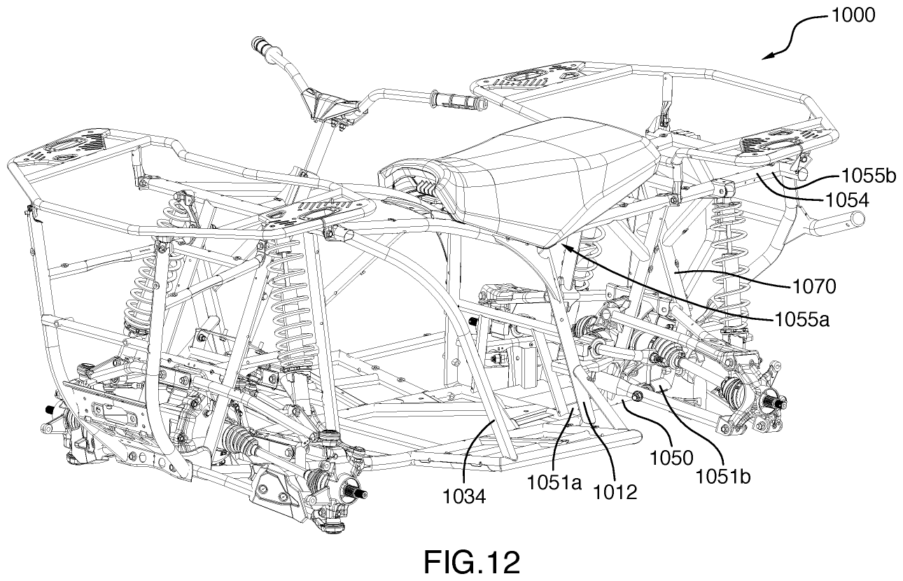

Referring to FIG. 11, a right footrest subframe 1036 for supporting a footrest extends sidewardly from the right lower and upper tubes 1004, 1008. Likewise extending sidewardly from the left lower and upper tubes 1002, 1006 is a left footrest subframe 1034 for supporting a footrest, as shown in FIG. 12. Left and right footrest subframes 1034, 1036 provide a structure or frame onto which can be mounted left and right footrests. Furthermore, as it will be appreciated, left and right footrest subframes 1034, 1036 contribute to the overall rigidity of the frame assembly 1000.

Referring now to FIGS. 29 and 30, a rear portion of the frame assembly 1000 comprises left and right lower tubes 1050, 1052, as well as, left and right upper tubes 1054, 1056. Left lower tube 1050 comprises a front end 1051a attached to the cross-member 1023 as well as a rear end 1051b. Likewise, right lower tube 1052 comprises a front end 1053a attached to the cross-member 1023, and a rear end 1053b. The left and right lower tubes 1050, 1052 are substantially straight and converge towards one another, from the front ends 1051a, 1053a to the rear ends 1051b, 1053b thereof, while being substantially parallel to the ground when seen from the side (e.g., FIGS. 13 and 14). Referring to FIG. 29, the left and right lower tubes 1050, 1052 are also connected to one another by way of at least one cross-member 1060. The rear portion is configured to accommodate one or more drivetrain components and/or to have such components mounted thereto.

Returning to FIGS. 11 to 14, left upper tube 1054 of the rear portion comprises a front end 1055a and a rear end 1055b, the front end 1055a being attached to the left upwardly extending tube 1012 (see FIG. 12). Likewise, right upper tube 1056 of the rear portion comprises a front end 1057a and a rear end 1057b, the front end 1057a being attached to the rear right upwardly extending tube 1016 (see FIG. 11). As seen from the top (see FIG. 30), the left and right upper tubes 1054, 1056 of the rear portion diverge away from one another, from their respective front ends 1055a, 1057a, towards their rear ends 1055b, 1057b. Connecting the rear ends 1055b, 1057b of the left and right upper tubes 1054, 1056 is an upper rear cross-member 1062. The left and right upper tubes 1054, 1056 are also connected to one another by way of at least one cross-member 1063, extending in intermediate locations between the front ends 1055a, 1057a and the rear ends 1055b, 1057b of the left and right upper tubes 1054, 1056.

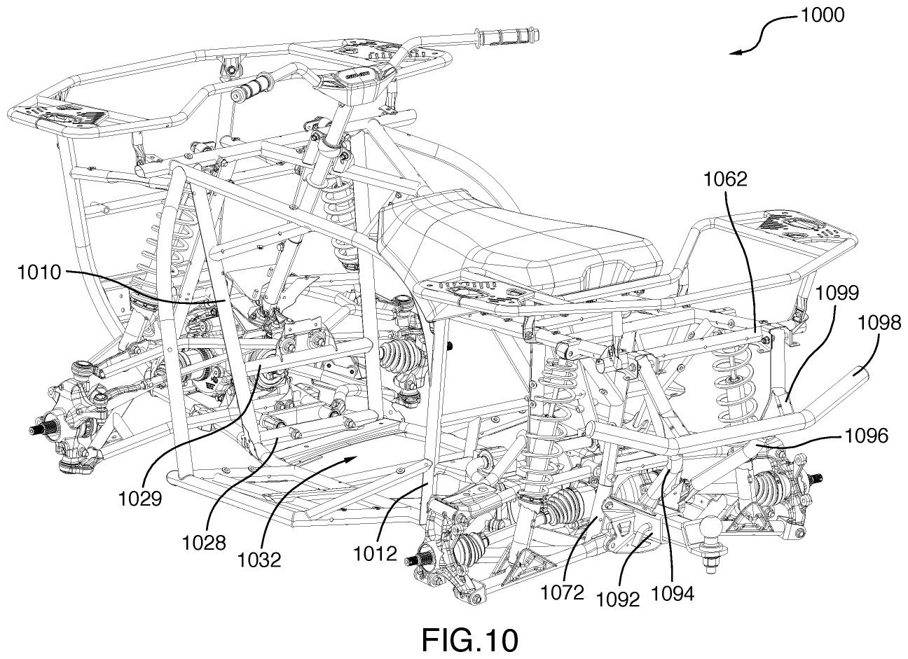

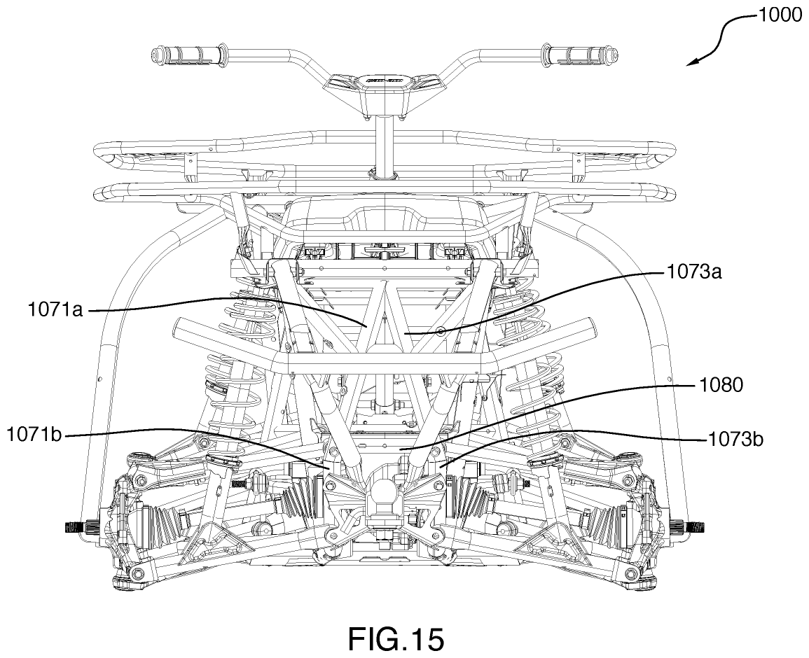

Extending between a midpoint on a cross-member 1063 between the left and right upper tubes 1054, 1056, and the left and right lower tubes 1050, 1052, respectively, are left and right angular tubes 1070, 1072 (see FIG. 15). As best shown in FIG. 15, left angular tube 1070 comprises a top portion 1071a and a bottom portion 1071b. Likewise, right angular tube 1072 comprises a top portion 1073a and a bottom portion 1073b. Extending proximal to the junction of the top and bottom portions 1071a, 1073a and 1071b, 1073b, between the left and right angular tubes 1070, 1072, is a cross-member 1080. A lower cross-member (not shown) may extend at a bottom end of the bottom portions 1071b, 1073b of the left and right angular tubes 1070, 1072. Bottom portions 1071b, 1073b are substantially parallel, while top portions 1071a, 1073a extend from the bottom portions to the midpoint on a cross-member 1063 or on another cross-member extending between the rear left and right upper tubes 1054, 1056, converging and connecting to the cross-member at an apex. A rear rack 1090 is mounted to the rear portion (see FIG. 14). A hitch assembly 1092 is secured to the bottom portions (see FIG. 10). Extending from the bottom portions 1071b, 1073b, or from the hitch assembly 1092, are left and right rear bumper support tubes 1094, 1096 (best shown in FIG. 10). The rear bumper support tubes 1094, 1096 extend outwardly and rearwardly from the bottom portions or from the hitch assembly 1092 to the upper rear cross-member 1062, diverging such that the left rear bumper support tube 1094 connects to the upper rear cross-member 1064 at a left end thereof, and the right rear bumper support tube 1096 connects to the upper rear cross-member 1062 at a right end thereof. A rear bumper support cross-member 1098 is supported by the rear bumper support tubes 1094, 1096 and connected thereto by means of brackets 1099. It is understood that other connection and/or securing means are possible.

### Frame With Electrical Drive Components

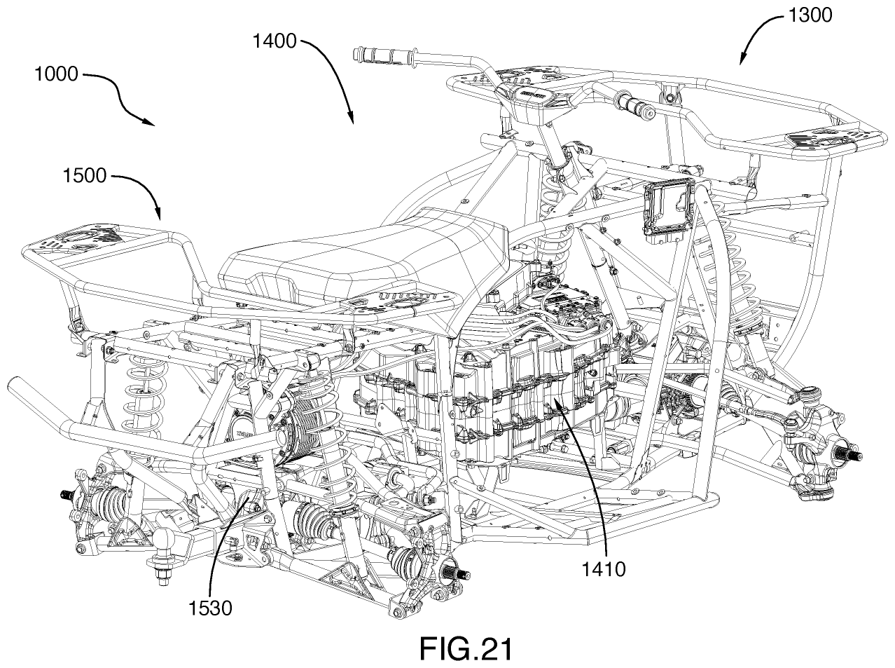

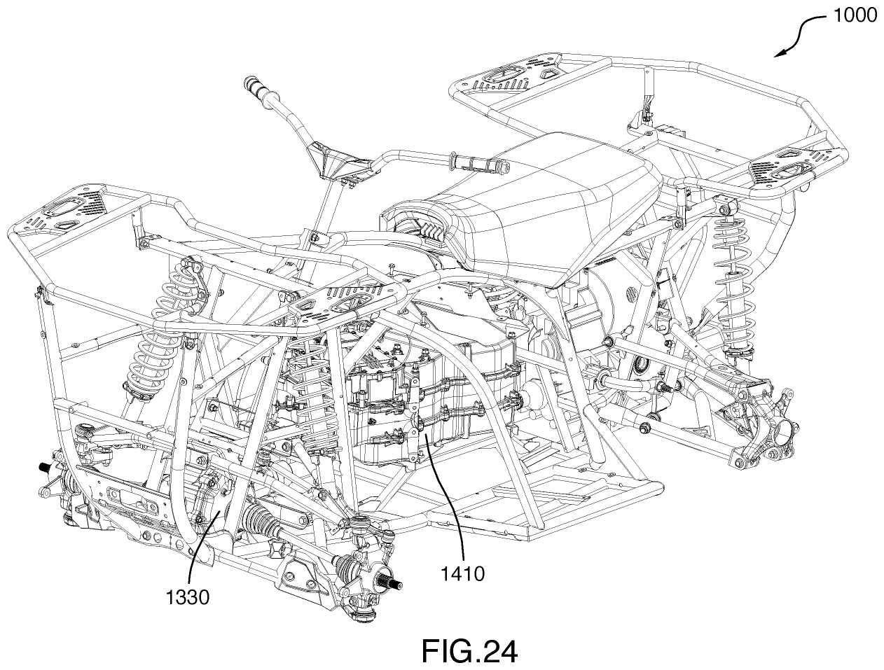

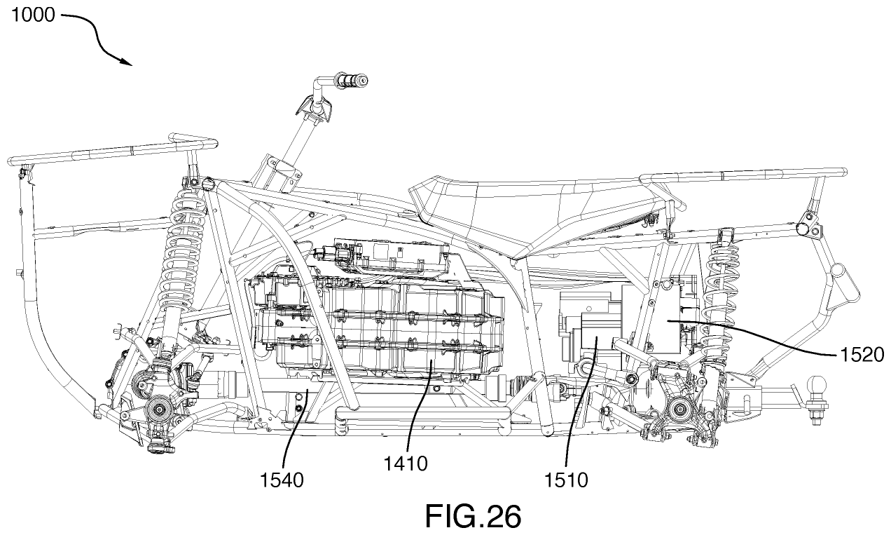

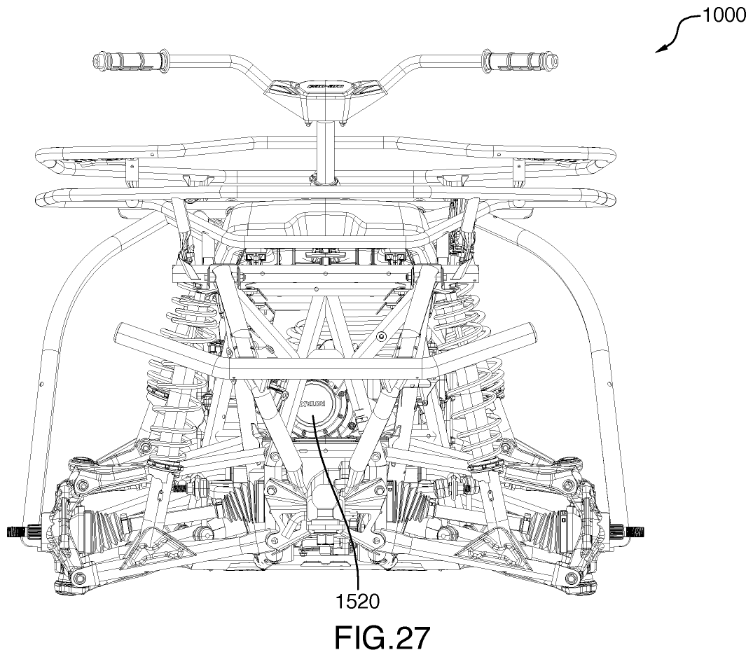

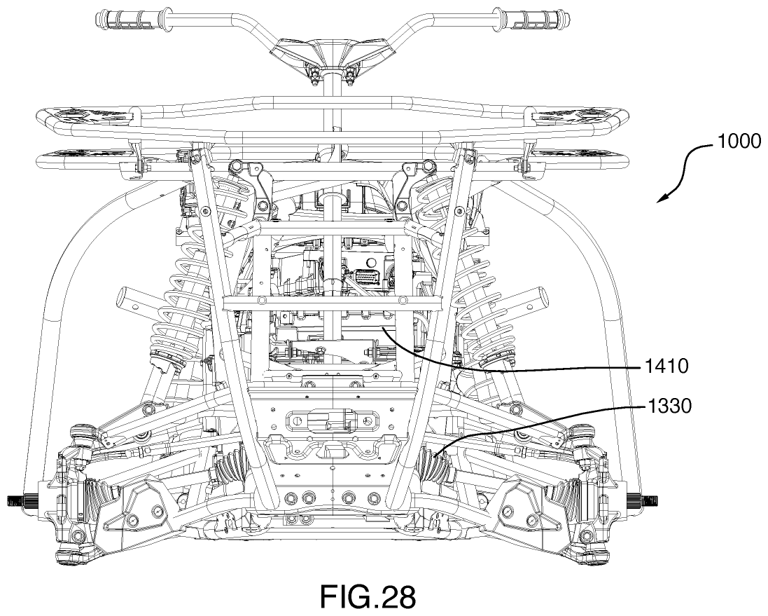

Referring now to FIGS. 21 to 38, the frame assembly 1000 has a front portion 1300 configured to support at least one front wheel, a middle portion 1400, and a rear portion 1500 configured to support at least one rear wheel. The middle portion 1400 connects the front portion 1300 and the rear portion 1500. Any one or more of the portions 1300, 1400 and 1500 may have one or more of the components of the off-road vehicle mounted thereto.

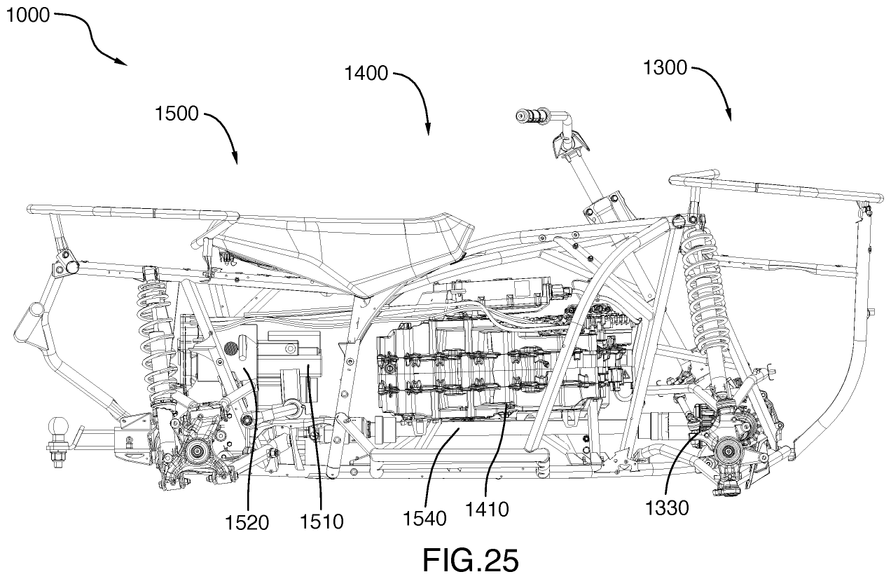

As shown on FIG. 25, a single electric motor 1510 is operatively coupled to the front and rear wheels (not shown) of the off-road vehicle 10. More specifically, in the illustrated embodiment, the electric motor 1510 is mounted to the rear portion 1500 of the frame assembly 1000 while a battery assembly 1410 is mounted to the middle portion 1400. The battery assembly 1410 provides electric power to the electric motor 1510 and is operatively and electrically coupled thereto using acceptable means. In the illustrated embodiment, a rear gearbox 1520 is mounted to the rear portion 1500 and operatively coupled to the electric motor 1510.

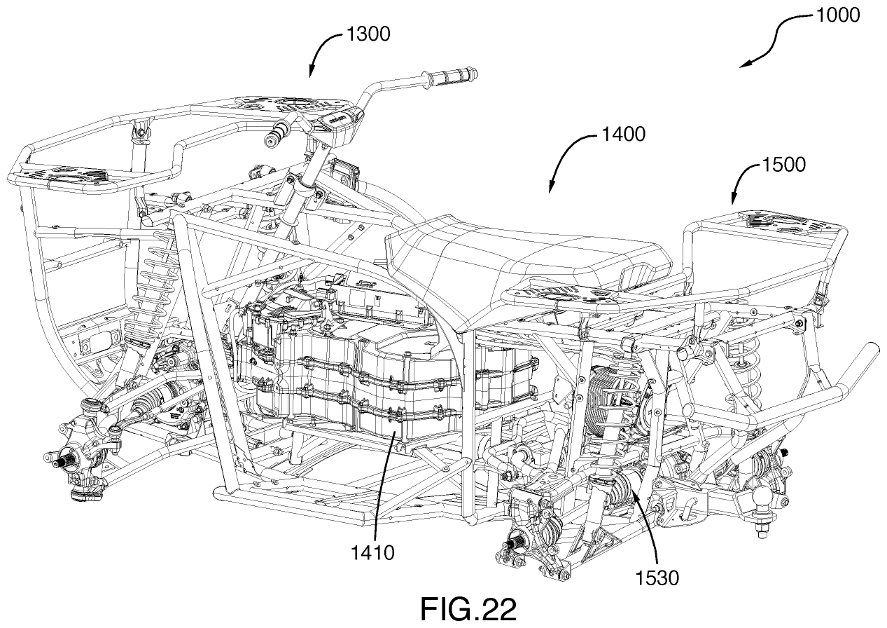

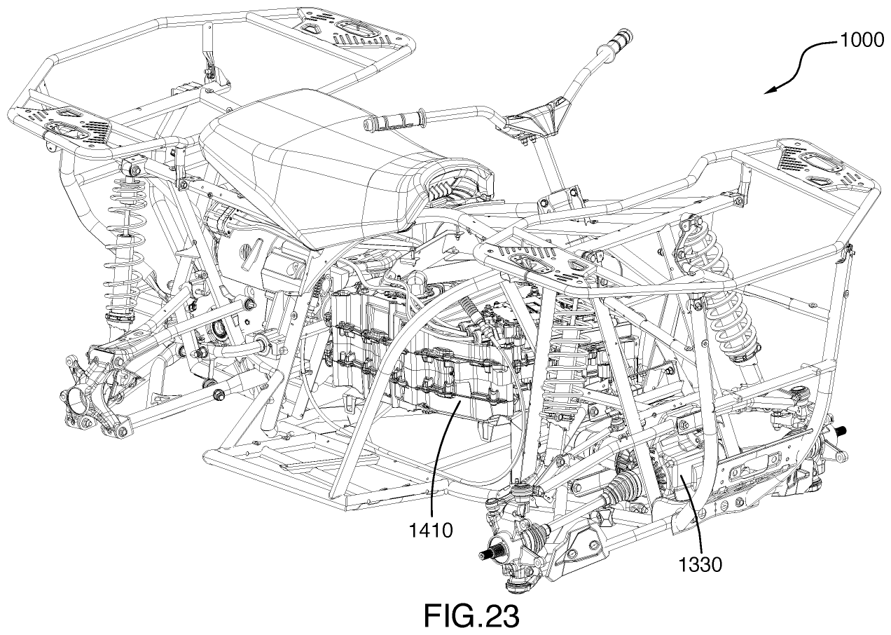

As shown in FIGS. 21 and 22, the rear portion 1500 has a rear final drive unit 1530 mounted thereto, configured to be operatively coupled to at least one rear wheel (not shown). The front portion 1300 has a front final drive unit 1330 mounted thereto (see FIG. 23), configured to be operatively coupled to one or more front wheels (not shown in FIGS. 21-38). The rear final drive unit 1530 is operatively coupled to the rear gearbox 1520 and to a driveshaft 1540 for transferring torque from the electric motor 1510 to at least of the rear wheels for propelling the same. As shown in FIG. 25, the front final drive unit 1330 is operatively coupled to the driveshaft 1540 for transmitting torque and/or force from the electric motor 1510 to at least one of the front wheels.

The present disclosure allows an electric motor to provide an amount of torque that is substantially equivalent to the torque provided by a combustion engine. This contributes to reducing engine size and weight and offsets at least a portion of the weight of the battery. It is understood that an overall weight of the vehicle may depend on the size, capacity and technology of the battery and of other drivetrain components.

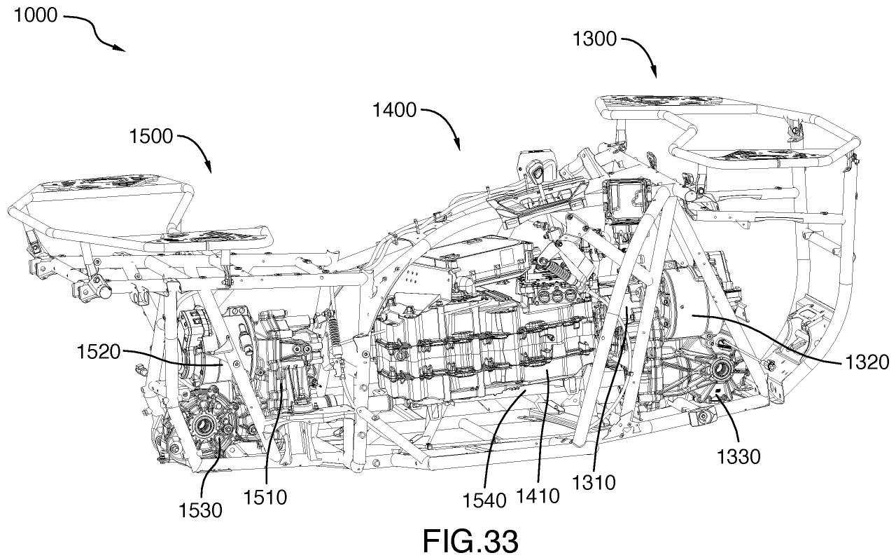

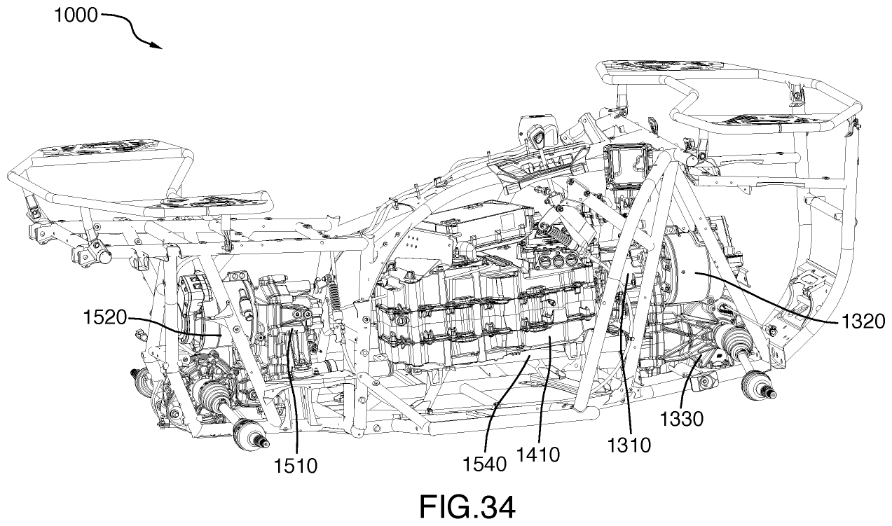

Referring now to FIGS. 33 and 34, there is described an alternate embodiment of elements of an off-road vehicle 10, in which front and rear electric motor 1310, 1510 are provided to propel front and rear wheels (not shown), respectively. In this embodiment, the frame assembly 1000 is provided with the battery assembly 1410 mounted to the middle portion 1400, a rear electric motor 1510, a rear gearbox 1520 and a rear final drive unit 1530 provided on the rear portion 1500, and the front electric motor 1310, a front gearbox 1320 and the front final drive unit 1330 mounted to the front portion 1300 of the frame assembly 1000. A driveshaft 1540 is configured to transmit torque from the electric motor 1510 to the front and rear wheels (not shown) and is operatively coupled to the front gearbox 1320 and the rear gearbox 1520.

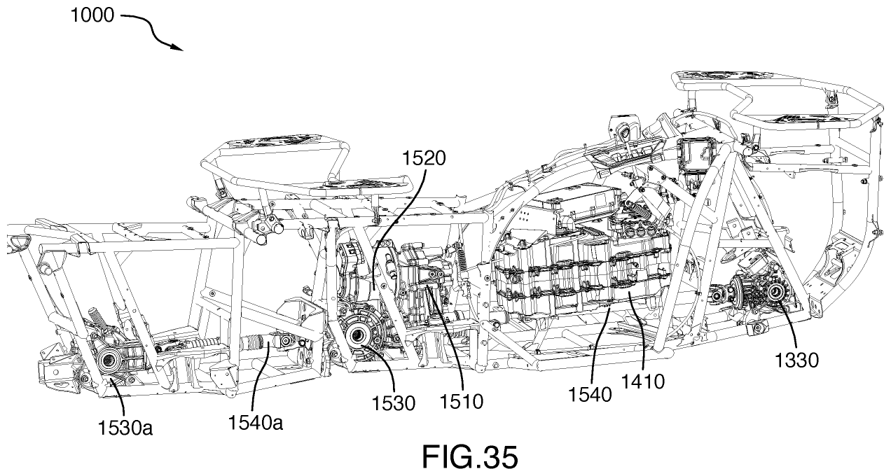

Referring to FIG. 35, according to another embodiment, the frame assembly 1000 is provided with a single electric motor 1510 and configured to receive two pairs of rear wheels mounted rearwardly one of the other, and one pair of front wheels. More specifically, the rear portion 1500 has a first rear final drive unit 1530 mounted thereto, operatively coupled to a first rear wheel (not shown) and a second final drive unit 1530a operatively coupled to a second rear wheel (not shown). For example, the off-road vehicle may be a six-wheeled ATV comprising two pairs of rear wheels. The rear portion 1500 has a rearward driveshaft 1540a installed therein, operatively coupling the first rear final drive unit 1530 to the second rear final drive unit 1530a for simultaneously transferring torque from the rear electric motor 1510 to the first and second rear wheels. Accordingly, the rearward driveshaft 1540a transferring torque simultaneously to each of the pairs of rear wheels may provide a more uniform torque delivery across the rear wheels. The forward driveshaft 1540 is installed in the frame assembly 1000 for transmitting torque to the front final drive unit 1330.

A single electric motor may thus provide four- and six-wheel drive functionalities to an off-road vehicle when necessary. Flexibility in operating an off-road vehicle is thus improved, for example by choosing between a four-wheel and a six-wheel configuration, and modulating the power of the electric motor.

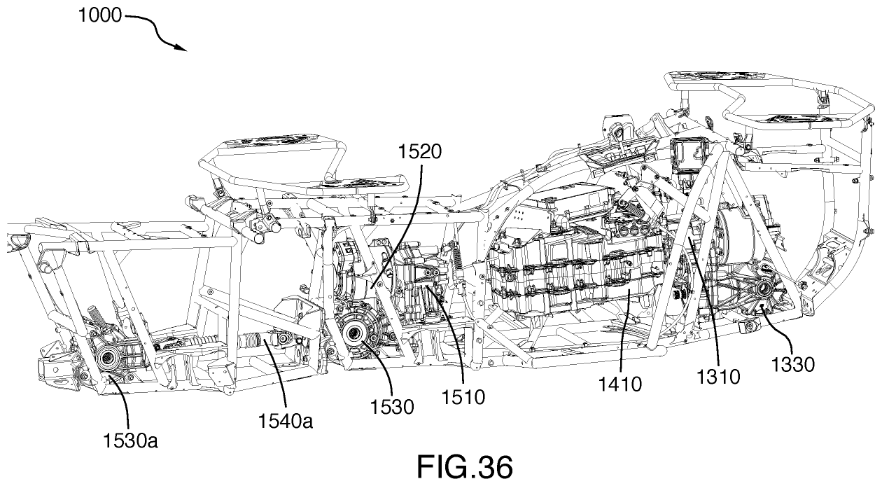

With reference to FIG. 36, there is shown an embodiment similar to the one illustrated in FIG. 35, except that the frame assembly 1000 is provided with a rear electric motor 1510 operatively coupled to the first rear final drive unit 1530 and a front electric motor 1310 operatively coupled to the front final drive unit 1330, instead of providing power to the front final drive unit 1330 by way of a forward driveshaft.

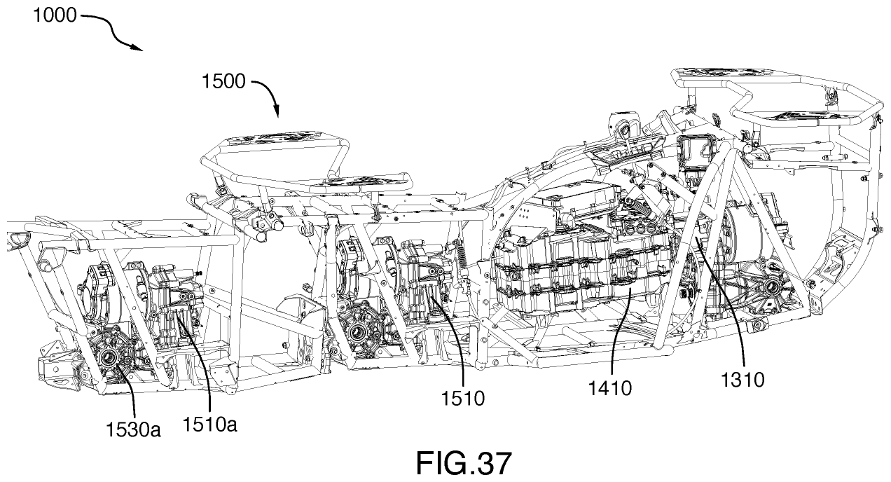

Referring now to FIG. 37, according to an embodiment, the frame assembly 1000 has two rear electric motors 1510, 1510a and two rear final drive units 1530, 1530a mounted to the rear portion 1500. Each electric motor 1510, 1510a is coupled to one final drive unit 1530, 1530a and to one pair of wheels (not shown). A user of an off-road vehicle comprising the frame and the drivetrain components above may adapt the operating parameters of each electric motor and each pair of wheels. As a non-limiting example, a user may deactivate one of the rear electric motors 1510, 1510a when the off-road vehicle does not require strong traction, for example on a flat, hard terrain, and engage the motor 1510 or 1510a when traction is required, for example if the terrain becomes hilly, muddy or otherwise challenging.

In some multi-motor configurations, the absence of one or more longitudinal driveshafts increases overall off-road vehicle efficiency. Torque may also be more finely controlled between axles.

In one embodiment, each of the electric motors 1510, 1510a and 1310 is mounted to the frame assembly 1000 via at least one mounting point. The mounting point may be a bracket, for example a bracket extending inwardly from one of the tubes, members or cross-members described above. For example, the rear portion 1500 may comprise a plurality of mounting points (not shown), comprising a plurality of mounting brackets (not shown) attached to or adjacent to one or more of the tubes and/or cross-members 1012, 1016, 1054, 1056, 1062, 1070, 1072, 1080 as previously described of the rear portion 1500. The mounting brackets may comprise connectors (not shown) for mounting one of the one or more electric motors 1510, 1510a, 1310 thereto. It is understood that each of the one or more electric motors 1510, 1510a, 1310 comprises connectors for allowing respective mounting of the motor 1510, 1510a, 1310 to the mounting point. The mounting point may be rigid, for example the mounting point may be a rigid bracket. The mounting point may be a flexible mounting point configured to dampen, reduce or eliminate vibrations that would be transmitted by the frame assembly 1000 to the electric motor 1510 and vice versa. For example, the flexible mounting point may comprise a mounting bracket configured to bend or to otherwise deform. The flexible mounting point may comprise one or more resilient materials, for example rubber or silicone or other suitable resilient materials. The flexible mounting point may comprise one or more resilient components, for example springs.

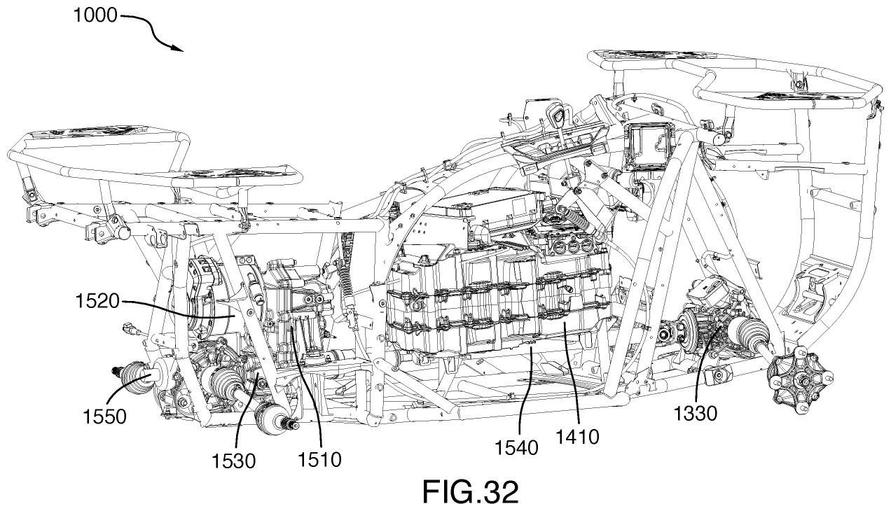

Referring now to FIG. 32, the off-road vehicle 10 may be provided with a power take-off (PTO) means for transmitting torque to a component or a system coupled thereto. Shown in FIG. 32 is a PTO shaft 1550 operatively coupled to at least one of the rear gearbox 1520 and/or rear final drive unit 1530 for delivering torque and/or motor power to an external component, for example a hydraulic pump, a mechanical arm, a pneumatic tool, and other systems that may be powered by PTO means (not shown). The power delivered by power take-off means from vehicles can be better modulated and controlled through the use of an electric motor. Accordingly, the present disclosure allows PTO power to be applied to more systems and/or tools.

While FIG. 32 shows a PTO shaft 1550 for providing PTO capabilities to the off-road vehicle 10, it is understood that the PTO means may be any other acceptable PTO means, for example a coupling assembly operatively coupled a gearbox or a final drive unit of the off-road vehicle, the coupling assembly being configured to receive a PTO shaft and/or to couple thereto. For example, an external component, for example a hydraulic pump, may comprise a PTO kit comprising a PTO shaft suitable for coupling to the coupling assembly. The coupling assembly may be configured to operatively couple to PTO shafts of different sizes and/or configurations, or may be configured to receive adapters for such different sizes, which adapters may be comprised in a kit. Accordingly, the off-road vehicle 10 may provide PTO power to a wide variety of tools and/or machines.

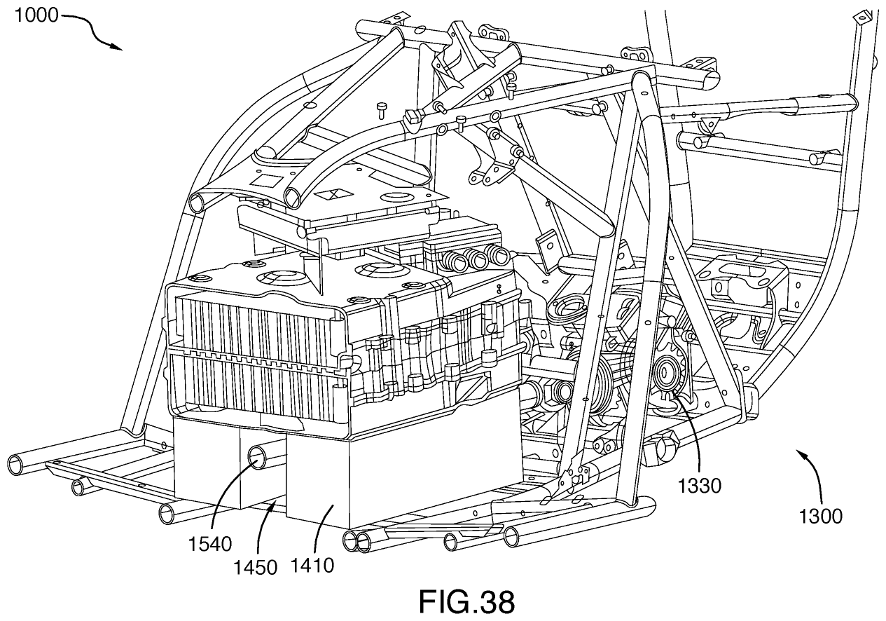

Referring now to FIG. 38, an exemplary arrangement of a battery assembly 1410 and of a driveshaft 1540 is presented. A driveshaft 1540 operatively coupled to a front final drive unit 1330 is configured to transmit torque from a motor (not shown) situated in the rear portion (not shown) to a front final drive unit (not shown). It is understood that the driveshaft 1540 may instead transmit torque from a front motor to at least one rear drive unit, or transmit torque from a plurality of motors to a plurality of final drive units. The battery assembly 1410 is configured to allow the passage of the driveshaft 1540 by defining a channel 1450 for passing the driveshaft 1540 therethrough. The battery assembly 1410 may be configured for allowing the passage of the driveshaft 1540 under the battery assembly 1410 (as shown in FIG. 31), or above the battery assembly 1410.

The present disclosure thus provides for component configurations for an electric off-road vehicle allowing the use a straight driveshaft when necessary, improving vehicle efficiency.

The principles discussed above with respect to two or more rear wheels and two or more rear final drive units may apply with the necessary adaptations to suitable configurations of the front wheels of the off-road vehicle. Accordingly, the front portion 1300 may comprise two or more front wheels positioned rearwardly and/or forwardly of each other and a plurality of front final drive units. The off-road vehicle may comprise a forward driveshaft operatively connecting the front final drive units for simultaneous torque transmission to the front wheels.

It is understood that the plurality of electric motors may be controlled independently by a user of the off-road vehicle or by an on-board computer. For example, a user may deactivate a front electric motor if the off-road vehicle is stuck with the front wheels having no traction and direct the battery's energy to the rear motor or motors and to the rear wheel or wheels for moving the vehicle. For example, a user may deactivate the front motor when reversing. Other methods and uses of independently controlled motors on an off-road vehicle will be apparent to a skilled person.

Combinations of two or more motors, transmissions and final drive units allow for improved efficiency, reduced costs and reduced component volume for an off-road vehicle. Reduced component number and/or size also improves ergonomics and increases available cargo space. The size and/or capacity of some components may be increased, for example by providing a larger and/or higher-capacity battery for greater off-road vehicle autonomy.

While FIGS. 21 to 38 show the motors 1510, 1510a and 1310 in an assembled state, a general discussion of their operation is presented. The one or more electric motors of the off-road vehicle may deliver power through one or more output shafts (not shown), each output shaft being coupled to one motor. The output shafts may extend parallel or perpendicular to a longitudinal axis extending from a front end to a rear end of the off-road vehicle, and may be operatively coupled to a final drive unit 1530, 1530a, 1330, to a rear gearbox 1520, to a driveshaft 1540, 1540a or to a wheel (not shown) for transmitting torque thereto and/or for propelling the off-road vehicle. For example, the rear electric motor 1510 may comprise an output shaft (not shown) extending rearwardly parallel to the longitudinal axis for operatively coupling the electric motor 1510 to the rear gearbox 1520. In a non-limiting embodiment, the rear electric motor 1510 may comprise an output shaft extending perpendicularly to the longitudinal axis, for example outwardly towards a side of the off-road vehicle or downwardly. The rear gearbox 1520, the rear final drive unit 1530 and/or the driveshaft 1540 may be accordingly adapted. For example, the rear gearbox 1520 may be sidewardly adjacent to the rear electric motor 1510 and an output shaft may couple the rear electric motor 1510 to the rear gearbox 1520, extending sidewardly perpendicular to the longitudinal axis. It is understood that other arrangements are possible and that the rotational axis of a torque-transferring component may be changed by acceptable means including, but not limited to bevel gears, final drive units and other suitable systems and mechanisms. For example, an off-road vehicle may comprise a rear electric motor having a downwardly extending output shaft, coupling the electric motor to a rear gearbox, and a bevel gear situated at any point between the electric motor and the driveshaft, for example the driveshaft 1540, for converting a rotation along an axis perpendicular to the longitudinal axis to a rotation substantially parallel to the longitudinal axis.

Any one of the drivetrain components as described above may be operatively coupled to a transmission, the transmission allowing a range of rotation speeds transferred to at least one wheel during operation of at least one electric motor. For example, the transmission may allow transferring one of a neutral speed, a high speed and a low speed. The transmission may be a continuous variable transmission (CVT), allowing a range of speeds to be transmitted. The transmission may be configured to transfer a range of torque output values and/or torque levels. It is understood that other transmission configurations, including but not limited to configurations allowing the transfer of more speeds are possible.

While the embodiments shown in FIGS. 21 to 38 show a frame assembly 1000 for an off-road vehicle having a rear gearbox 1520 and, in embodiments, a front gearbox 1320 mounted thereto, when the off-road vehicle is a hybrid vehicle, the off-road vehicle may comprise more than one gearbox, each gearbox being operatively coupled to a motor or an engine for transmitting torque and motion therefrom. For example, in a hybrid embodiment, a gearbox may be operatively coupled to a combustion engine (not shown) and another gearbox may be coupled to each one of the one or more electric motors. In embodiments comprising more than one electric motor, two or more gearboxes may be operatively connected to the plurality of electric motors, each gearbox being operatively connected to at least one of the electric motors.

In embodiments, the off-road vehicle 10 may be a hybrid off-road vehicle in which the internal combustion engine is configured to act as a generator. The internal combustion engine accordingly supplies electric power to vehicle components and charges the battery, and does not provide mechanical power or torque to the wheels. Advantageously, in such a configuration, the range of the off-road vehicle 10 having an electric powertrain is extended, allowing for continuous travel. The internal combustion engine thus acts as a range extender. The internal combustion engine may be configured to switch between delivering mechanical power and delivering electric power, or to provide both at the same time using acceptable power generation and transmission means.

The off-road vehicle may, on the other hand, not comprise any gearboxes. For example, the electric motor 1510 may be configured to generate speed, torque and/or force over a suitable range to operate the off-road vehicle on challenging terrain, for example on steep inclines, on ice and/or snow, in wet conditions, for towing purposes, and in other environments or conditions that would require engaging a low or high gear for increased power delivery. Accordingly, when the one or more electric motors are configured to deliver sufficient speed, torque and/or force, gearboxes may be omitted. When a gearbox is not present, a driveshaft 1540, 1540a may be operatively coupled to a final drive unit.

In a non-limiting embodiment, a rear electric motor is mounted to the rear portion of the frame assembly, one rear gearbox is mounted to the rear portion of the frame assembly and operatively coupled to the rear electric motor, and a first rear final drive unit is mounted to the rear portion of the frame assembly, the rear gearbox being operatively coupled to the first rear final drive unit for transferring torque from the rear electric motor to the at least one rear wheel.

It is understood that other arrangements of the drivetrain components described above are possible. For example, in embodiments comprising two or more electric motors, the components described above may be arranged suitably for propelling the off-road vehicle. Any one or more of the front portion, the middle portion and the rear portion may comprise one or more electric motors mounted thereto.

It is also understood that the off-road vehicle 10 may be configured to switch between two or more drive modes, for example between a two-wheel drive mode, a four-wheel drive mode, a six-wheel drive mode and others. The switching may be accomplished using one or more acceptable switching technologies, for example by using a transfer case, or by selectively altering the configuration, engagement and/or activity of one or more electric motors, gearboxes and final drive units.

For example, the off-road vehicle may be a four-wheeled ATV and may comprise four electric motors, each operatively coupled to one of four wheels of the ATV. Accordingly, such an embodiment may comprise one or more gearboxes, for example four gearboxes each operatively coupled to one electric motor, or no gearboxes if the electric motors are configured to deliver sufficient speed, torque and/or driving force to the wheel to which they are operatively coupled. The off-road vehicle may comprise a rear electric motor, a rear gearbox and a rear final drive unit, and further comprise one front electric motor and one front gearbox operatively coupled to the front electric motor, as well as a front final drive unit operatively coupled to the front gearbox for transferring torque from the electric motor to at least one front wheel. Accordingly, a driveshaft operatively connecting an electric motor located in the rear portion 1500 or the middle portion 1400 to the front final drive unit 1330 for transferring torque thereto would not be present.

It is understood that the electric motor 1510 may be mounted to the front portion 1300, instead of the rear portion 1500. Accordingly, the off-road vehicle in such an embodiment would comprise one front electric motor, one front gearbox operatively coupled to the front electric motor and a front final drive unit operatively coupled to the front gearbox for transferring torque from the electric motor to the at least one front wheel. A rearward driveshaft extending from the front gearbox to the rear final drive unit may simultaneously transfer torque from the front electric motor to the at least one front wheel and the at least one rear wheel.

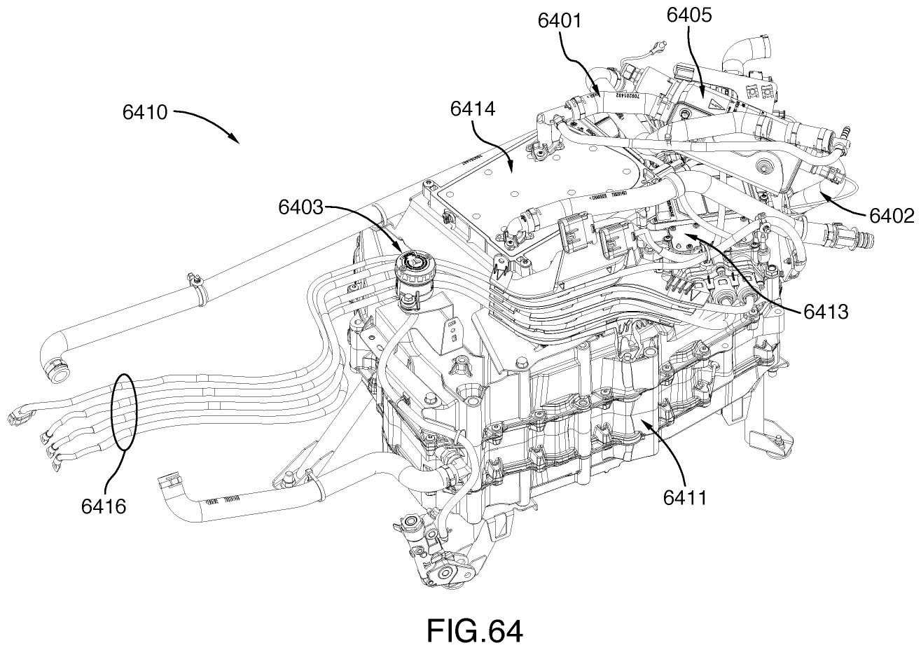

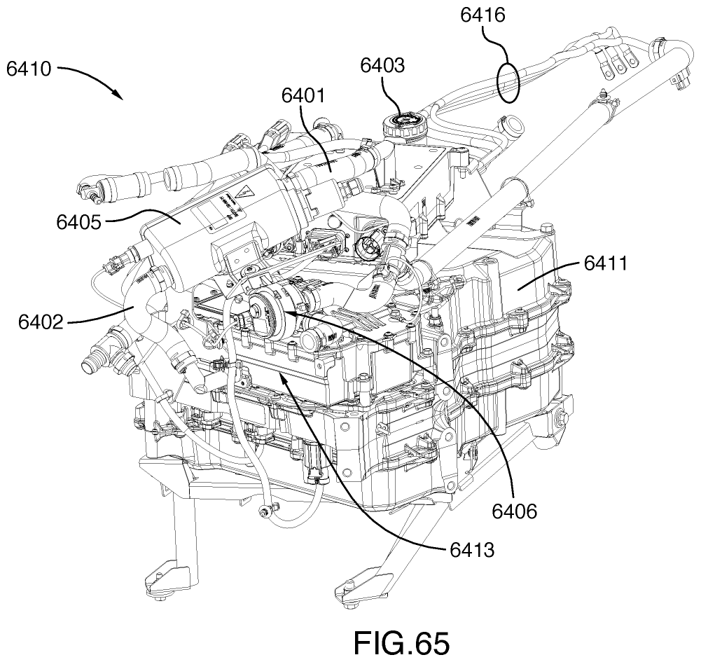

The off-road vehicle 10 may comprise a cooling circuit for cooling at least one electric motor, or optionally other components of the off-road vehicle that may require cooling, including but not limited to the battery assembly 1410, and other components susceptible of generating heat or requiring temperature control to operate effectively. It is further contemplated that alternative embodiments of the battery assembly are possible such that the cooling circuit may also comprise a heating circuit as will be discussed further hereinbelow with regard to FIGS. 64 and 65.

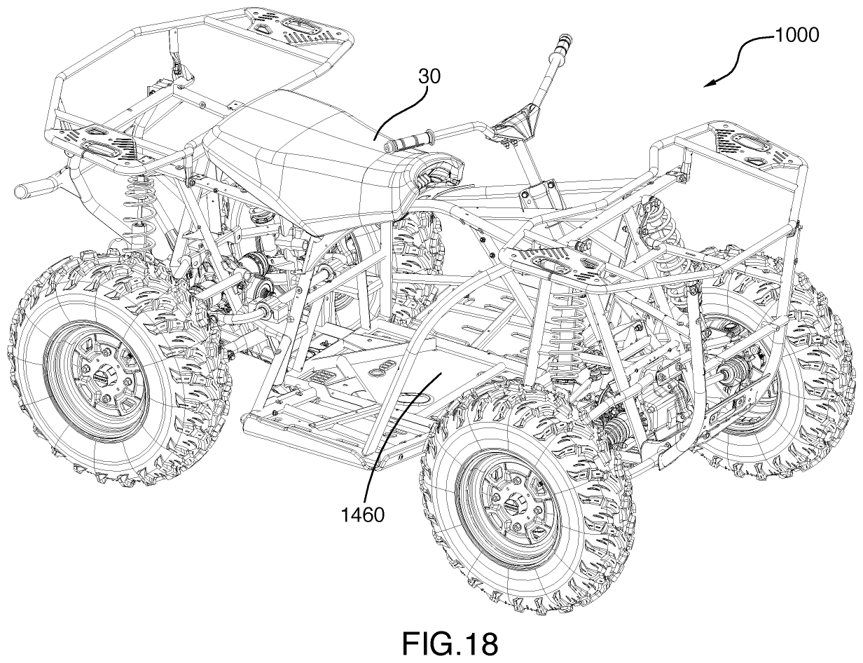

The battery assembly 1410 may be configured to be mounted to the frame assembly 1000 between the skid plate 1460 and the straddle seat 30 (shown in FIG. 18).

Optimizing battery placement and motor placement, as well as optimizing the number of motors, improves the stability of an off-road vehicle, including on difficult terrain, for example by providing a lower center of gravity or improved mass distribution, or both.

### Integrated Battery Assembly

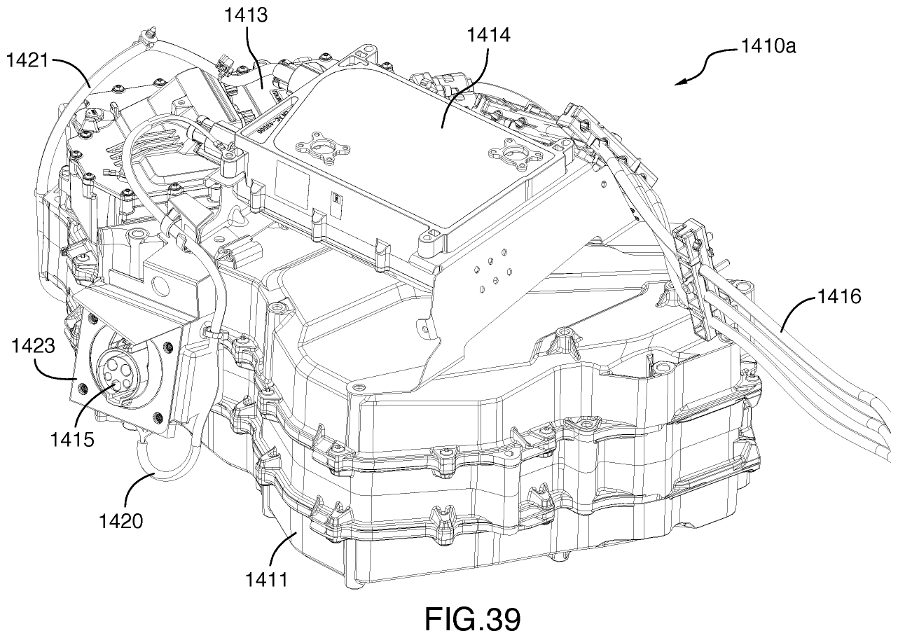

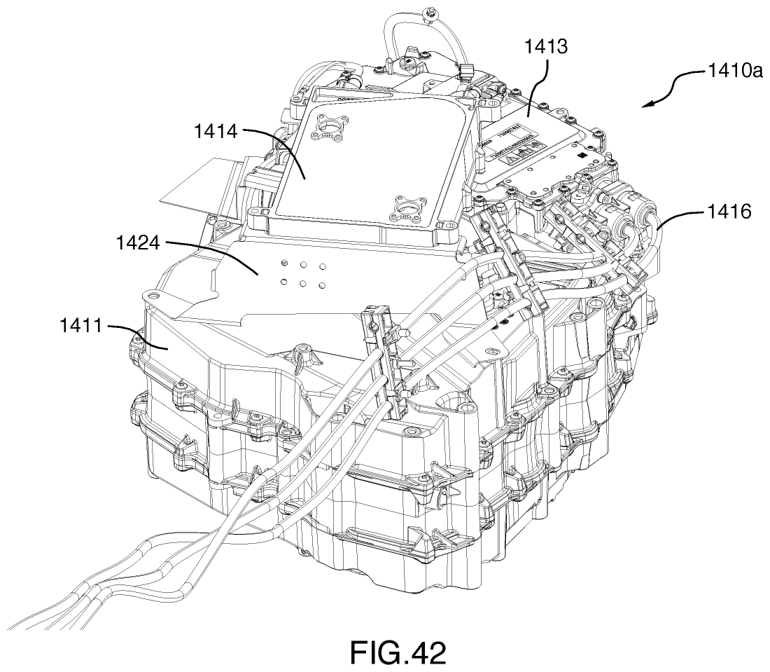

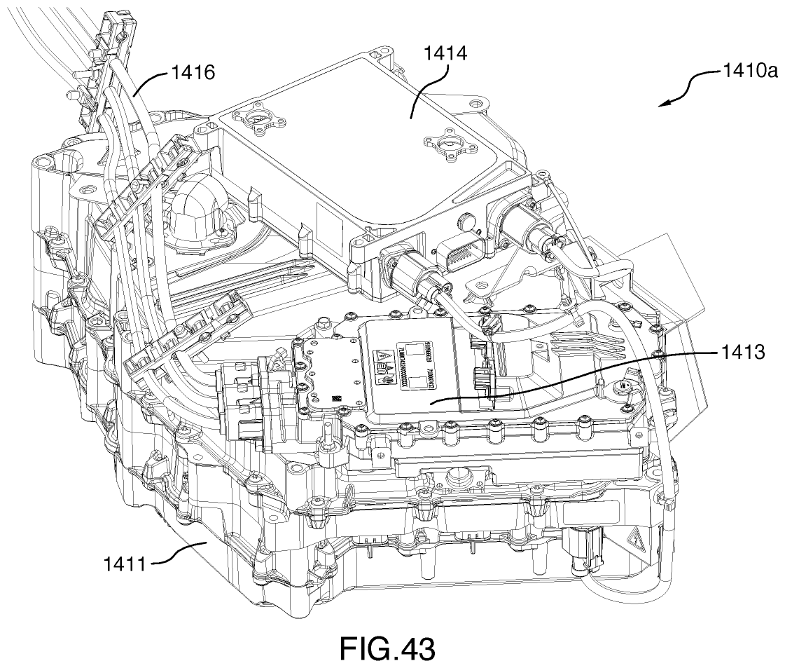

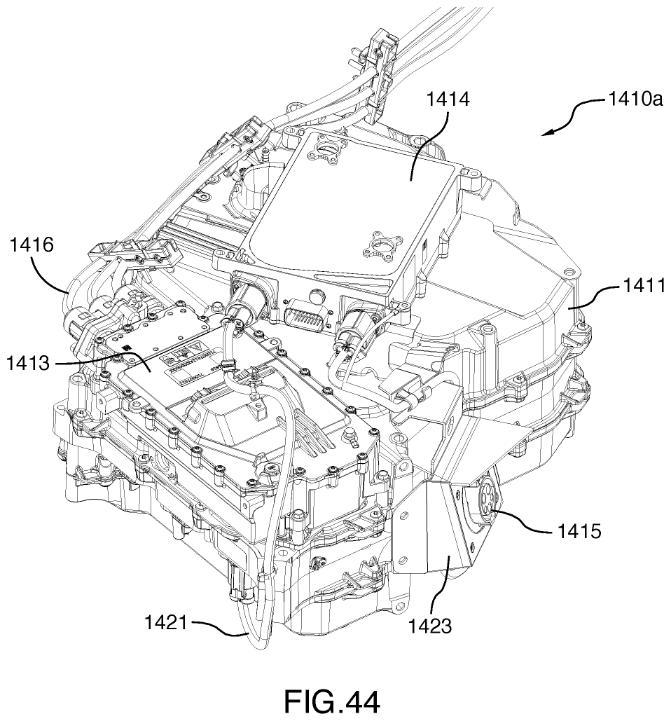

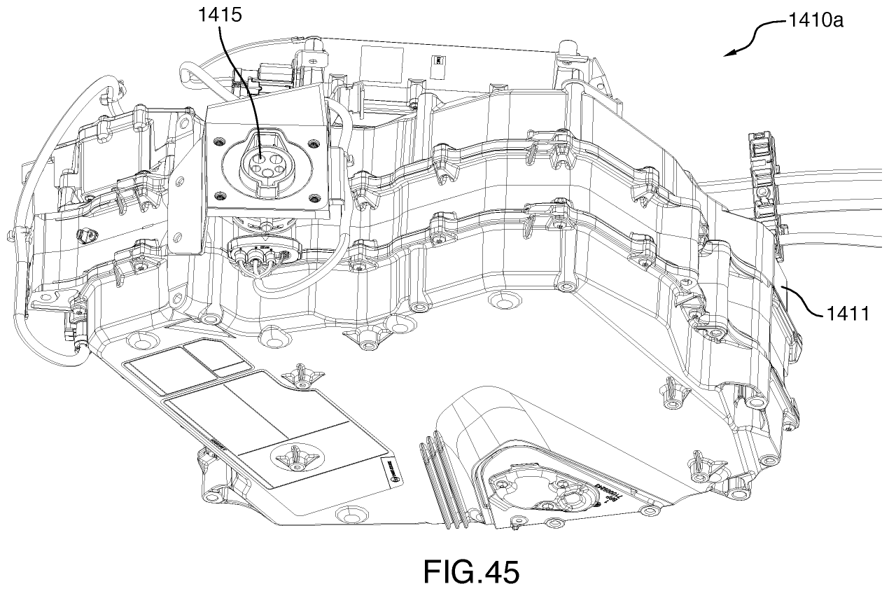

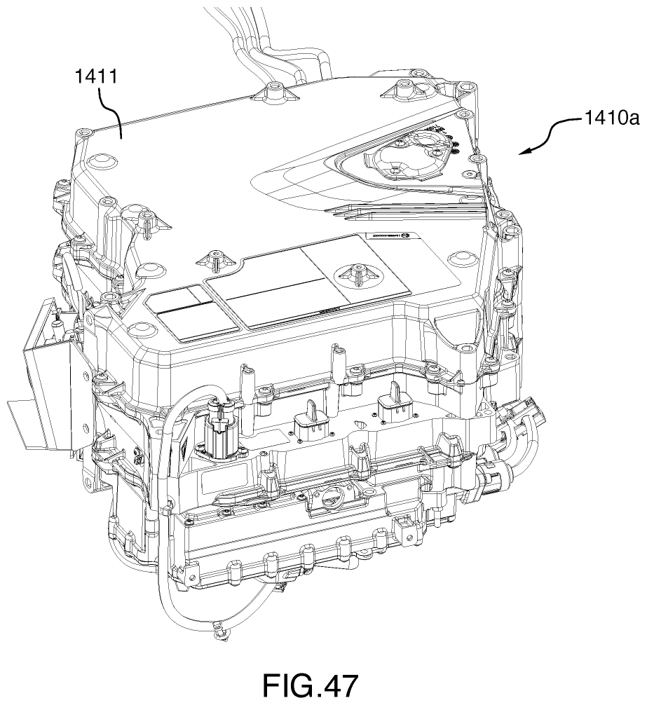

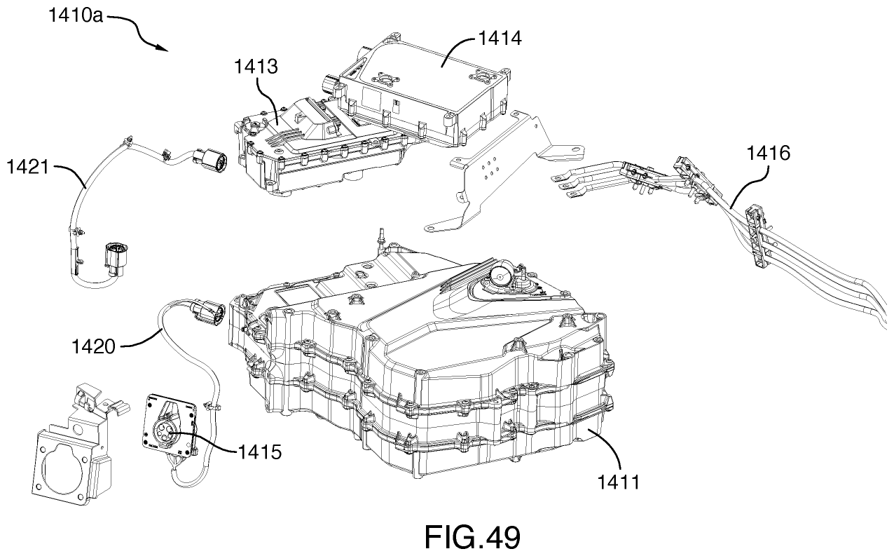

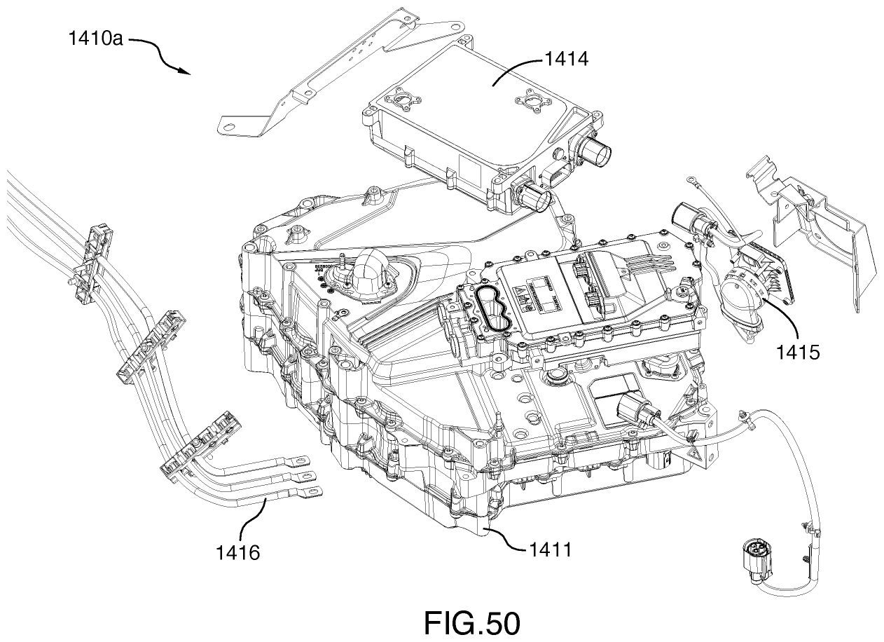

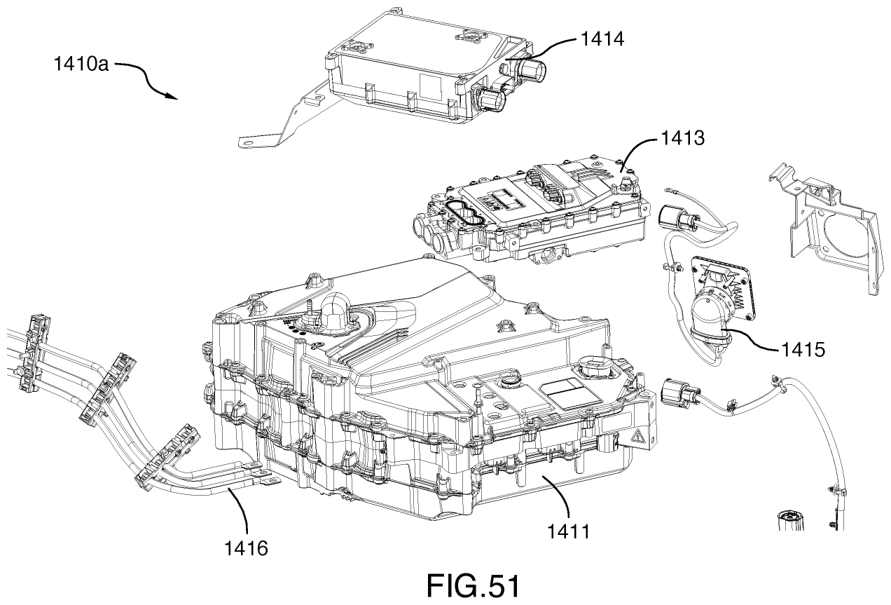

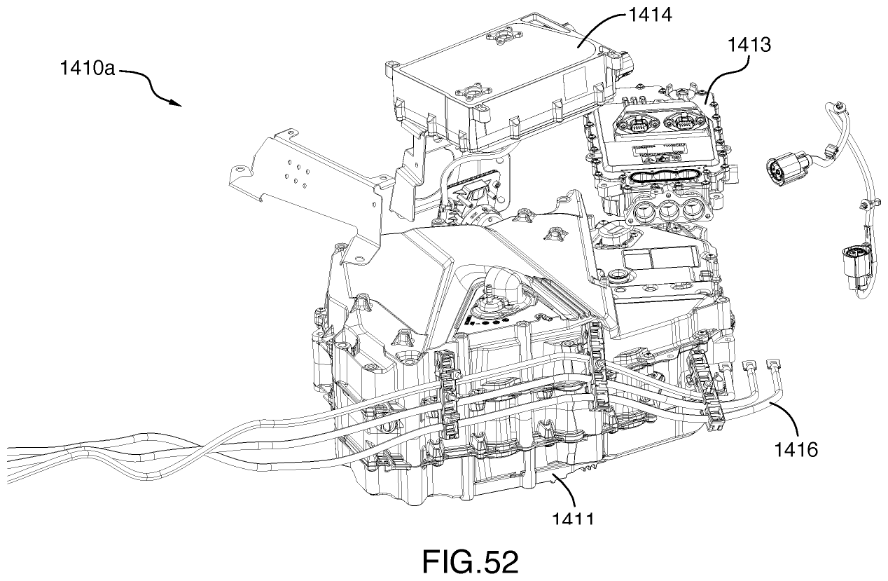

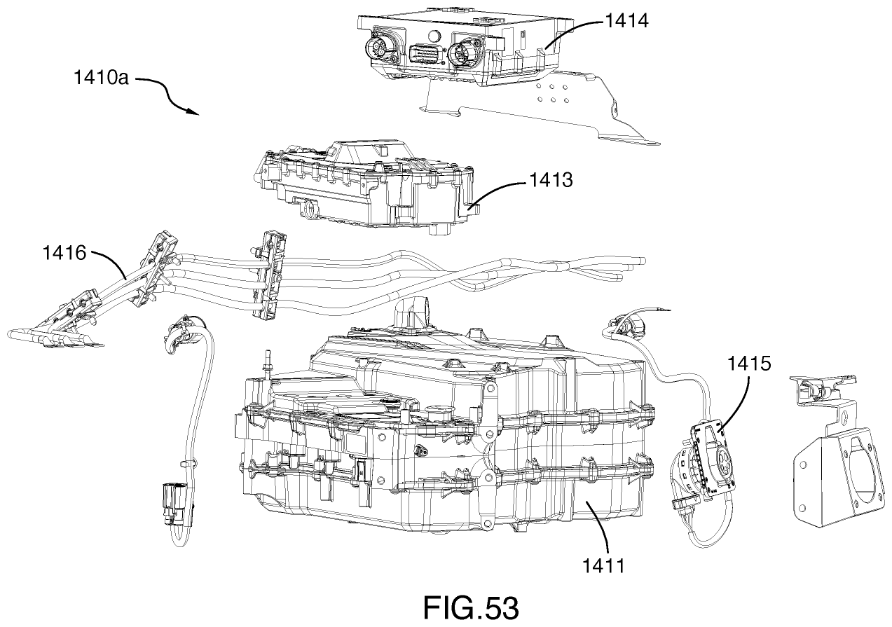

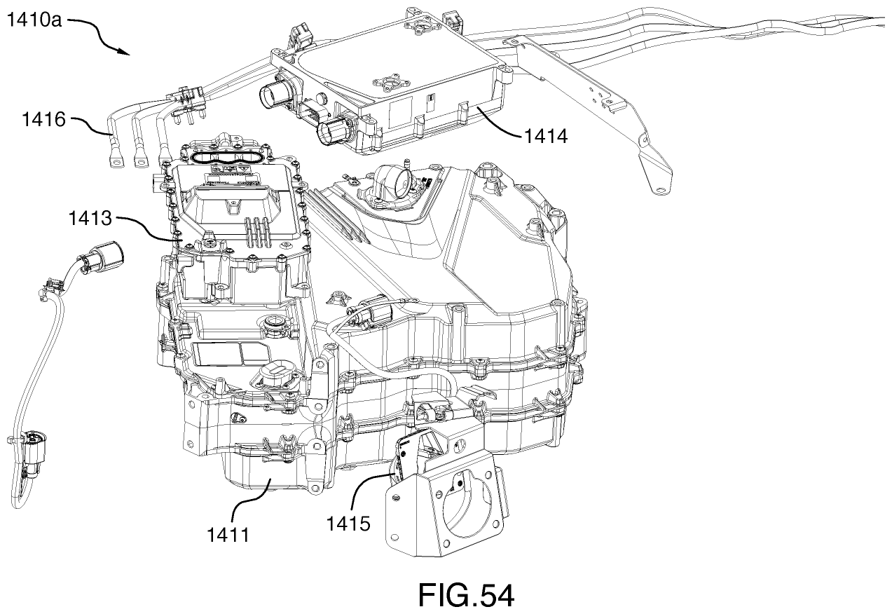

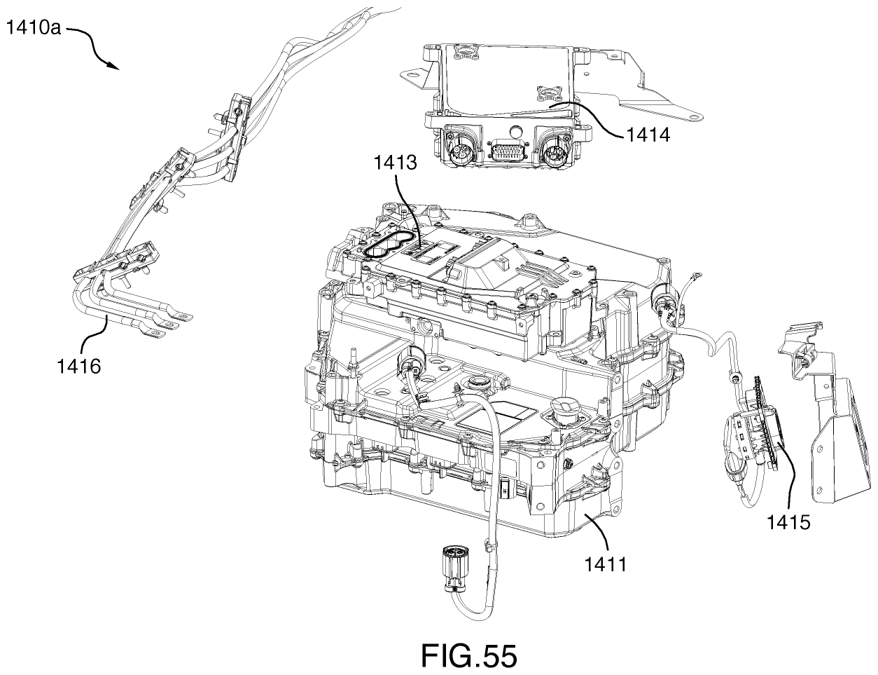

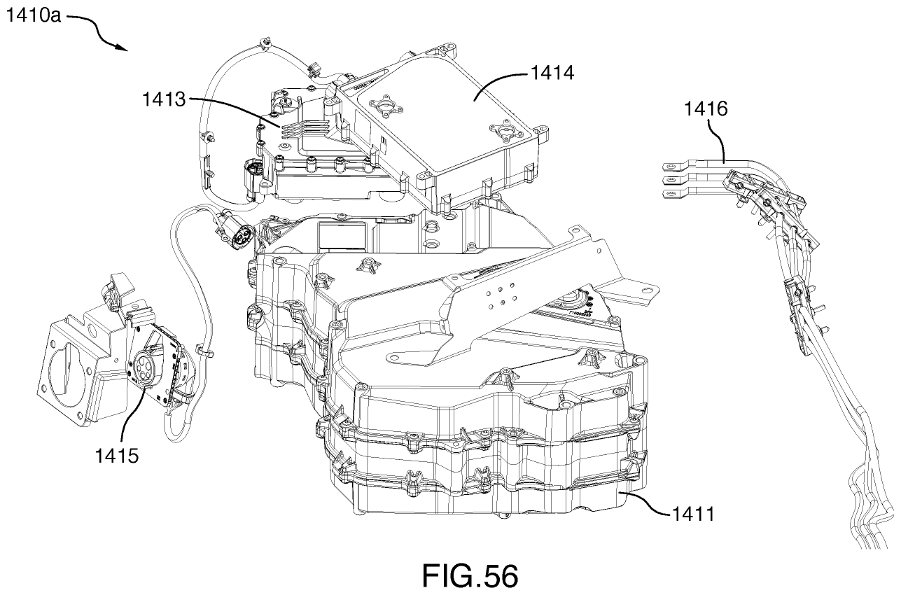

Referring now to FIGS. 39 to 58, embodiments of battery assemblies for an electric or hybrid off-road vehicle will be described. It is understood that the battery assemblies may be used for the off-road vehicle 10 as described herein, or in other electric or hybrid vehicles configured for receiving such battery assemblies.

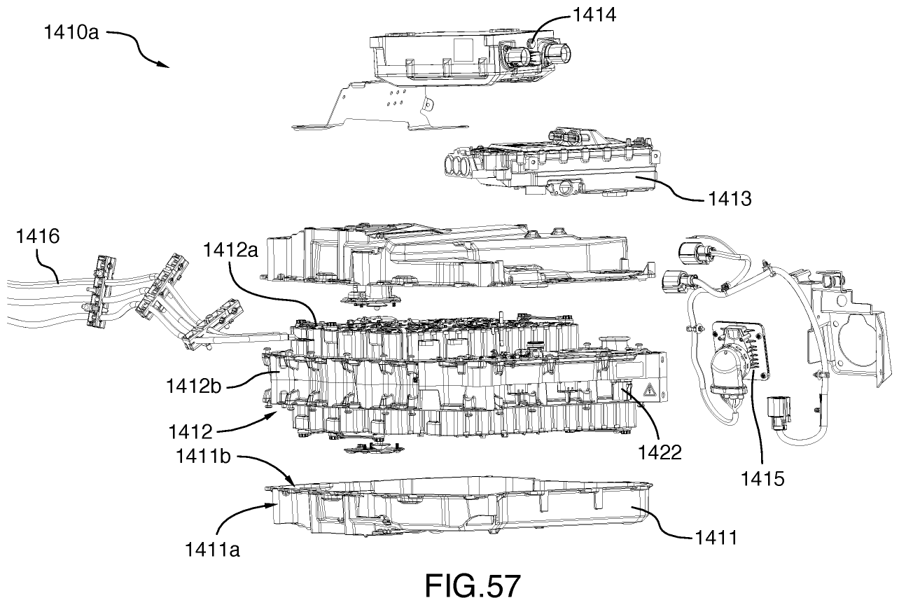

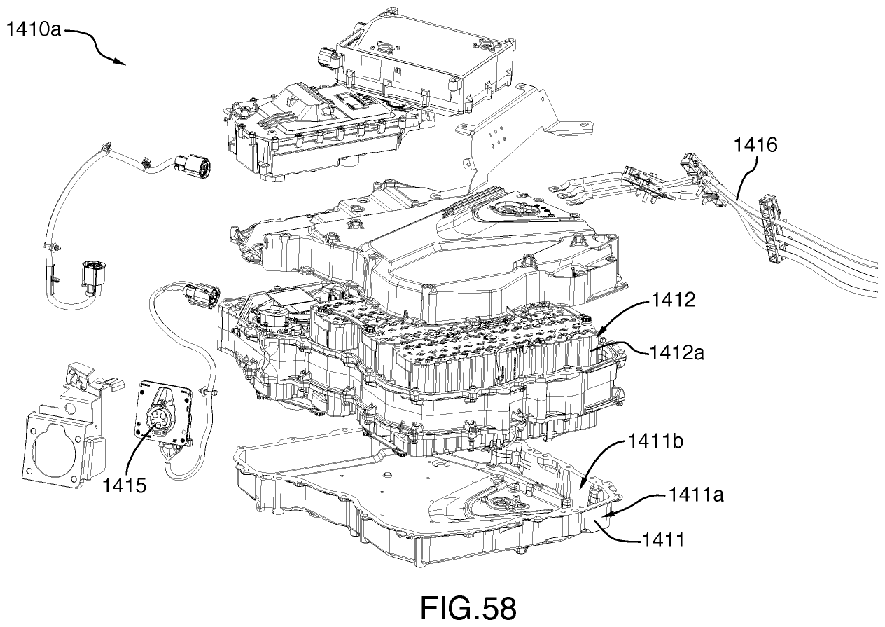

Referring more specifically to FIGS. 39, 57 and 58, a battery assembly 1410a comprises a housing 1411, the housing having an exterior side 1411a and an interior side 1411b (shown in FIGS. 57 and 58). The interior side 1411b of the housing defines a chamber (not shown) for receiving a battery pack 1412 therein (shown in FIGS. 57 and 58). The battery assembly 1410a further comprises at least one electrical connection 1422 extending from the battery pack 1412 towards the exterior side 1411a of the housing 1411, the at least one electrical connection 1422 comprising an interior end 1422a electrically connected to the battery pack 1412 and an exterior end 1422b located on the exterior side 1411a of the housing 1411. The battery assembly 1410a further comprises an inverter 1413, a charger 1414, a charging port 1415, at least one phase cable 1416 (three phase cables pictured in FIGS. 39 to 58) configured to carry an AC current secured to the exterior side of the housing 1411, the at least one inverter, charger, charging port, and phase cable being electrically connected to the exterior end of the electrical connection 1422 to connect the battery pack 1412.

It is understood that the battery assembly 1410a described above provides an integrated battery assembly having several components for its operation, installation and use incorporated thereto.

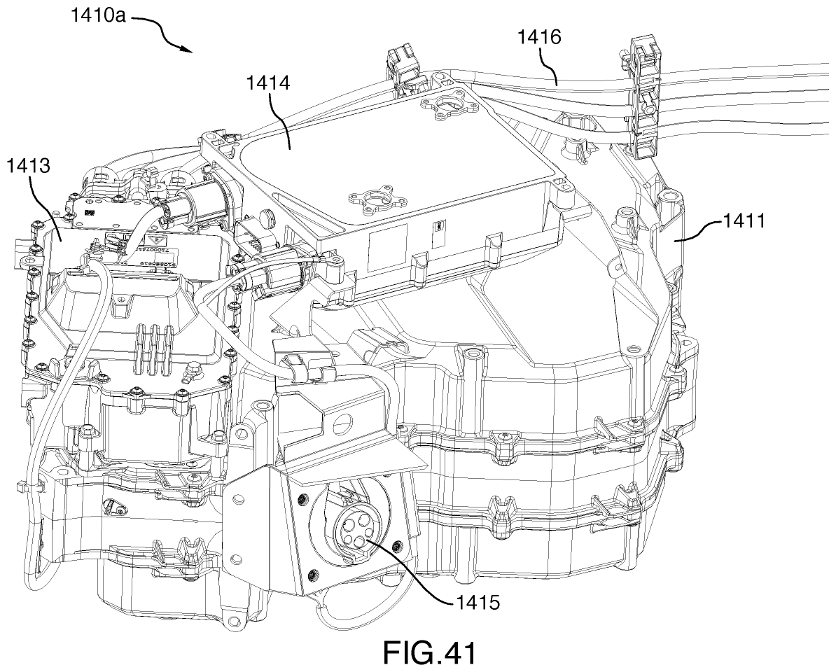

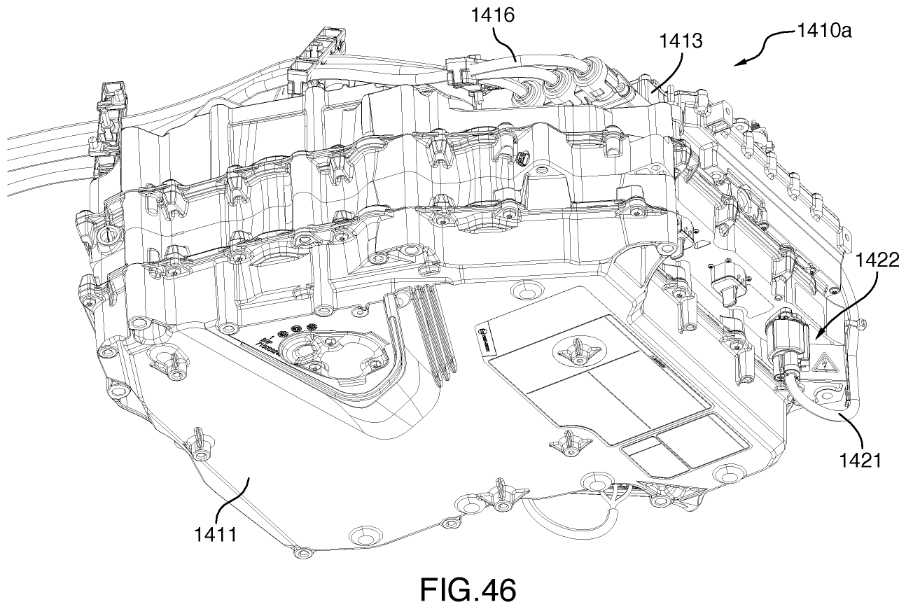

Referring to FIG. 41, the charging port 1415 is electrically connected to the charger 1414 via a cable 1420, configured to carry a single-phase high voltage AC current. The charger 1414 is configured to charge the battery pack 1412 via a charging cable 1421 configured to carry a high voltage DC current. As shown in FIG. 46, the charging cable 1421 is configured to engage the electrical connection 1422 (shown in an unengaged state in FIG. 57) at a bottom face of the housing 1411, the electrical connection 1422 allowing DC power to flow from the charger (not shown on FIG. 46) to the battery pack 1412. The electrical connection 1422 may be a component of the battery pack 1412 extending through the housing 1411. The electrical connection may also be a component of the housing 1411, configured to engage the charging cable 1421 and a corresponding electrical connection means on the battery pack 1412 for providing a flow of electricity therebetween.

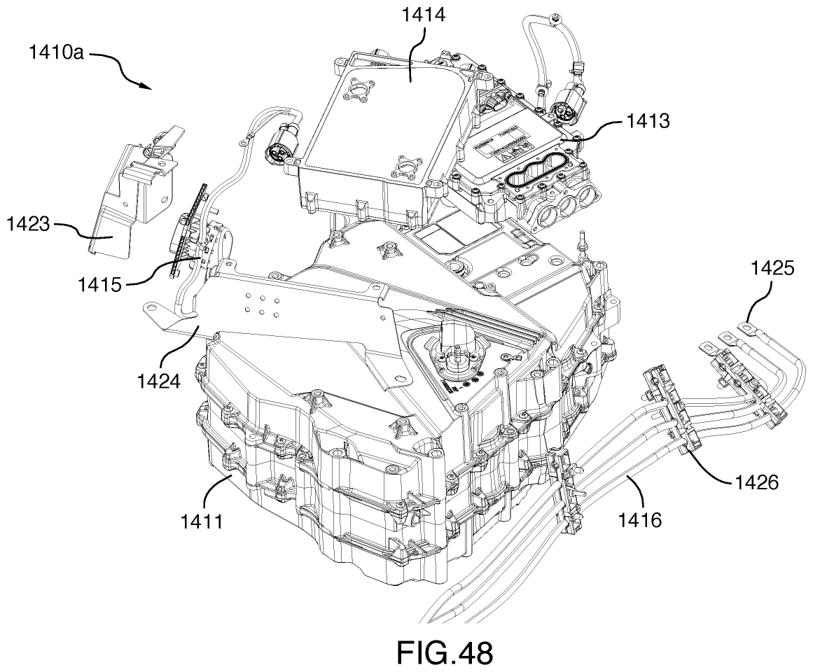

Appropriate securing means for any of the components 1413-1416 are provided. As shown in FIG. 48, the charging port 1415 is held in place, among other means, by a bracket 1423, and the charger 1414 is secured to the housing 1411 by means of a bracket 1424.

FIGS. 48 to 58 show phase cables 1416, having ends 1425 configured to be received in one or more screw terminals in the inverter 1413. It is understood that the phase cables 1416 may be provided with other connection means to the inverter 1413. For example, the ends 1425 of the phase cables 1416 may comprise one or more plugs configured to be received in one or more sockets on the inverter 1413. The phase cables 1416 are held in place with respect to each other by cable brackets or cable guides 1426. The cable brackets or cable guides 1426 may be configured to be secured to, or to engage with features or portions of the housing 1411 for reducing the range of motion of the phase cables 1416, for example during transport of the battery assembly 1410a.

The battery assembly 1410a may be assembled prior to installation in the off-road vehicle. For example, the off-road vehicle may be configured to receive a battery assembly such as battery assembly 1410a, and electrical components of the off-road vehicle may be configured for attaching or coupling to corresponding electrical assemblies on the battery assembly 1410a. In embodiments, one or more of the corresponding electrical assemblies of the off-road vehicle may be configured to matingly engage, click into or onto, or otherwise engage one or more of the components 1412-1416 upon the battery assembly 1410a being received in the off-road vehicle, i.e., without additional handling by a user. It is understood that the off-road vehicle may comprise a frame defining a compartment for receiving the battery assembly 1410a therein, and that the phase cable is configured to be connected to at least one of the electric motors of the off-road vehicle, for example to a rear electric motor 1510.

Referring now to FIGS. 48 to 58, exploded views of an exemplary battery assembly 1410a are presented. It is understood that the principles discussed herein apply with appropriate adaptations to the battery assembly 1410. As shown in FIGS. 57 and 58, the battery pack 1412 comprises a plurality of batteries or cells 1412a of a type and/or format appropriate for the off-road vehicle 10, including but not limited to cylindrical, prismatic, pouch-type, lithium-ion, nickel-metal hybrid, lead-acid, solid state, lithium sulfur batteries, other batteries, and/or combinations thereof.

It is understood that any of the components 1413-1416 may be secured to the battery assembly 1410a by any appropriate means, including but not limited to mounting brackets, clips, bayonet mounts and others. For example, the housing 1411 may comprise one or more mounting brackets on its exterior side, adapted for securing one or more of the components 1413-1416 thereto.

While the battery assembly 1410a has been described with reference to a charging port 1415 electrically connected to the charger 1414 and to the battery pack 1412 by means of cables 1420 and 1421, other means for conveying power from the charging port 1415 to the battery pack 1412 are possible. For example, the charger 1414 may be integrated into the housing 1411 and the charging port 1415 may thus be configured to provide power to the charger 1414 situated inside the housing via any acceptable means. For example, a portion of the housing 1411 may be configured to have an electrical connection suitable for receiving a charger on an inner side of the housing and a charging port on the outer side of the housing, and to provide an electrical connection therebetween.

The battery assembly 1410a may comprise a cold plate 1412b (see FIG. 57) or other means of cooling one or more components of the battery pack and/or providing temperature uniformity to the battery pack components. The cold plate 1412b is sandwiched between cells 1412a elements of the battery pack and provides means of dissipating heat from the cells 1412a and the battery pack. Other configurations for the cold plate 1412b or other acceptable cooling means for dissipating heat from the battery pack 1412 to the housing or to the outside are possible.

The battery assembly 1410a may additionally comprise at least one low-voltage cable or at least one additional high-voltage cable (not shown), configured to carry a DC current and electrically connected to the battery pack 1412. These cables could power one or more low or high voltage DC loads throughout the off-road vehicle 10, for example the headlights, control means, on-board computers or diagnostics, monitors, sensors, block heaters, trailer lights, heated jackets, connected helmets, and other peripheral components or attachments. Improving the availability of different currents supplied by the same battery assembly allows a user to diversify the components installed to, or powered by the battery assembly 1410a.

The battery assembly 1410a may comprise a DC-DC converter for converting DC voltages between high and low voltage, to power low voltage loads such as the headlights. The DC-DC converter may be found within the battery pack 1412, separate from the battery pack 1412 but within the housing 1411, or as a component secured to the exterior side 1411a of the battery housing 1411 and electrically connected to the battery pack 1412. The DC-DC converter may act similarly to an alternator in a combustion engine vehicle, to power low voltage loads.

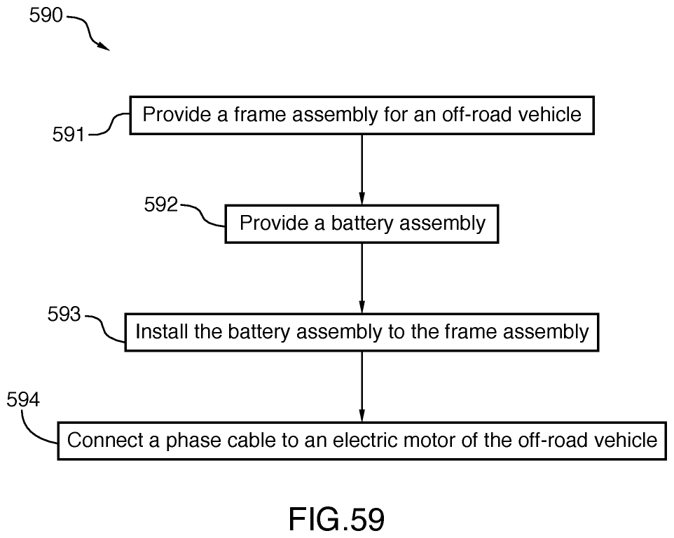

Referring now to FIG. 59, a method 590 of assembling an off-road vehicle will be described. The method comprises providing a frame assembly (591), for example frame assembly 1000 or another frame assembly suitable for an off-road vehicle according to the principles disclosed herein, where the off-road vehicle comprises a frame assembly, at least one front wheel, at least one rear wheel, and an electric motor mounted to the frame assembly and operatively coupled to at least one of the at least one front wheel and the at least one rear wheel. The method further comprises providing a battery assembly as described above (592), for example an integrated battery assembly such as the battery assembly 1410a comprising at least one phase cable 1416 and one or more of the components 1412-1415, installing the battery assembly to the frame assembly (593), and connecting the at least one phase cable to the electric motor (594). The off-road vehicle may be assembled by installing the battery assembly as described above and by installing at least one front wheel and at least one rear wheel. It is understood that at least one or more of the wheels of the off-road vehicle may be installed before or after the installation of the battery assembly.

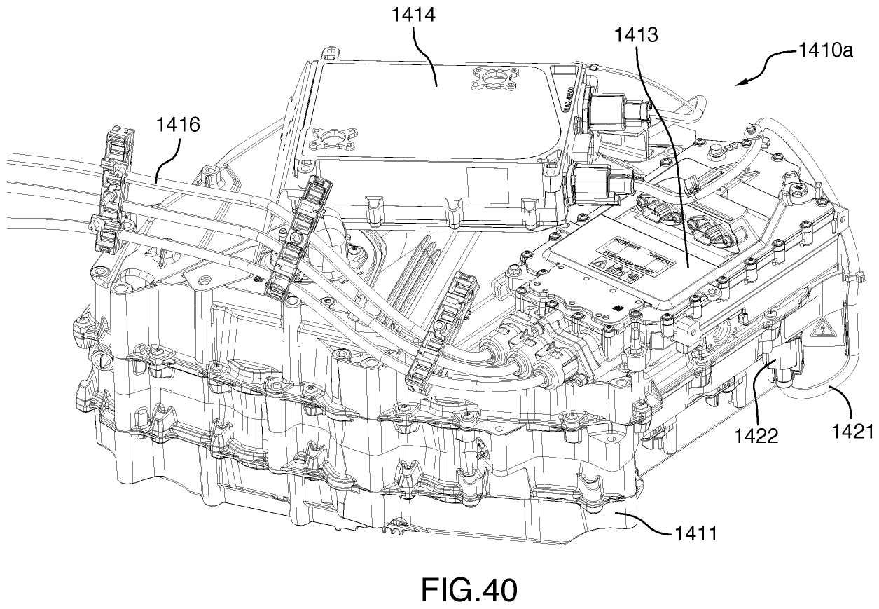

As previously mentioned above, the off-road vehicle may comprise a heating circuit for maintaining an optimal working temperature of the battery assembly. This is shown and described with regard to FIG. 64 which illustrates a front perspective view of a battery assembly in accordance with a further embodiment and FIG. 65 which illustrates a rear perspective view of the battery assembly of FIG. 64. Here, the further embodiment is substantially identical to the battery assembly of, for example, FIG. 40. However, several notable variations exist in FIGS. 64 and 65. These include a heating unit 6405 mounted atop the housing 6411 of the battery assembly. The heating unit 6405 includes an inlet conduit 6401 and outlet conduit 6402 that in which coolant flows through the cooling circuit previously mentioned hereinabove. Thus, it should be readily apparent that the battery may selectively be cooled or heated by the coolant depending upon the given environment within which the off-road vehicle is operating.

In particular, the heating unit 6405 will serve to heat the coolant circulated within the cooling circuit when, for example, the battery temperature is below 0° C. and the battery must be charged, or that the battery is below about −20° C. and power must be drawn from the battery (e.g., when the vehicle is going to be used). Ideally, electrical power is drawn from the charge port (i.e., when the off-road vehicle being plugged in to an electrical line source such as the public grid) and such electrical power is thereby used to heat the coolant which is circulated into the battery. However, it should be noted that it is also possible to draw power from the battery to power the heating unit 6405.

With continued reference to FIGS. 64 and 65, the coolant flows into the heating unit 6405 at the inlet conduit 6401 for heating therein. It should be readily understood that the heating unit 6405 will include suitable heating elements therein (not shown) such as, but not limited to, resistance heaters and controlled by either manual or automatic environmental temperature actuated circuitry (not shown) to activate the heating unit 6405 when a cold environment is encountered. Such details related to the heating elements and related circuitry is well known in the heating art and shall not be discussed further herein. Once suitably heated within the heating unit 6405, the heated coolant fluid exits the outlet conduit 6402 and flows through the cooling circuit previously mentioned hereinabove while first passing through the inverter 6413 and onward through the housing 6411 eventually entering the charger 6414 to return to the heating unit 6405 via the inlet conduit 6401. It should be understood that the coolant fluid's flow through the cooling circuit is provided by a coolant pump 6406. In the embodiment of FIGS. 64 and 65, there is also seen a brake fluid reservoir 6403 provided for the off-road vehicle's braking system (not shown). It should therefore be readily apparent that the battery assembly 6410 includes several elements fixed to the housing 6411 through one or more brackets. Such elements may therefore include at least one of an inverter electrically connected to at least one phase cable, a charger, a charging port, a high-voltage cable, a braking fluid reservoir, a coolant heater, and a coolant pump secured to the exterior side of the housing and which may be applicable to all embodiments of the battery assembly. Likewise, each of these elements are fixed to the battery assembly with a bracket. In the embodiment shown in FIGS. 64 and 65 as may be the case in all embodiments, the coolant heater and coolant pump may be both on the same bracket.

Battery components and high-voltage systems of off-road vehicles may thus be assembled outside the off-road vehicle prior to installation, saving time and improving user safety.

### Frame With Structural Battery

According to another broad aspect, the present disclosure provides a frame for an off-road vehicle comprising a structural battery and an off-road vehicle comprising the same.

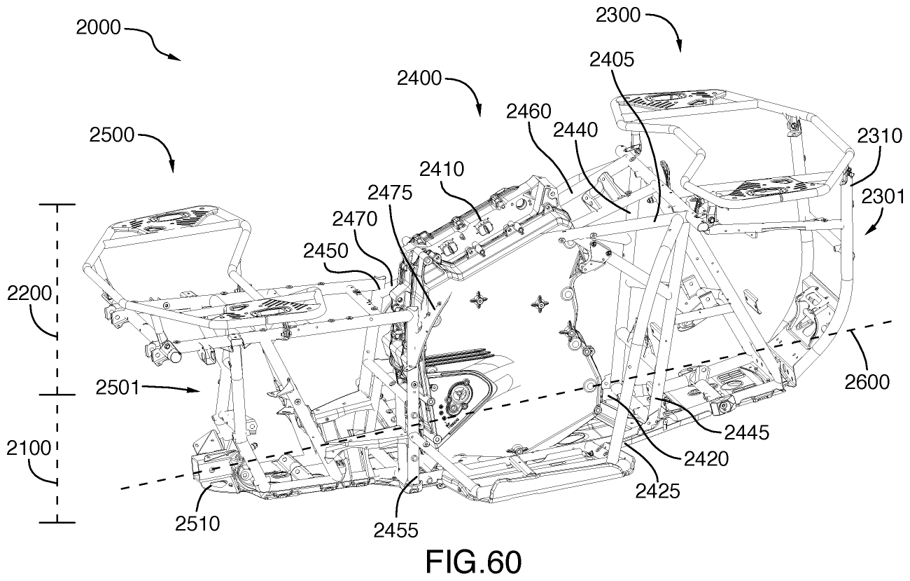

Referring to FIGS. 60 to 63, there is shown a frame assembly 2000 which comprises a front end 2301 and a rear end 2501, and a longitudinal axis 2600 extending from the front end to the rear end, shown in FIG. 60. The frame assembly 2000 also comprises a bottom section 2100 and a top section 2200, as well as a front portion 2300, a middle portion 2400 and a rear portion 2500.

The front portion 2300 is configured to support at least one front wheel (not shown), the rear portion 2500 is configured to support at least one rear wheel (not shown) and the middle portion 2400 connects the front portion 2300 and the rear portion 2500. The front portion 2300 comprises a front bumper assembly 2310, and the rear portion 2500 comprises a hitch assembly 2510.

Referring now to FIG. 60, an exemplary embodiment of a frame 2000 with a structural battery assembly is presented. It is understood that the features and configurations applicable to battery assemblies 1410 and 1410a apply, with the necessary adaptations, to the structural battery assembly 2410. The structural battery assembly 2410 is configured for receiving loads from the front portion 2300, the rear portion 2500 and/or the middle portion 2400. The structural battery assembly 2410 provides a connection between the front portion 2300 and the rear portion 2500.

In the illustrated embodiment, the middle portion 2400 comprises a left bottom longitudinal member 2420 and a right bottom longitudinal member 2425, the members extending in a direction substantially parallel to the longitudinal axis 2600 between the front portion 2300 and the rear portion 2500 and providing a structural connection between the front portion 2300 and the rear portion 2500 substantially within the bottom section 2100.

A front left upwardly extending member 2440 extends upwardly from a portion of the left bottom longitudinal member 2420 proximate to the front portion 2300 towards the top section 2200, and a right front upwardly extending member 2445 extends upwardly from a portion of the right bottom longitudinal member 2425 proximate to the front portion 2300 towards the top section 2200.

A rear left upwardly extending member 2450 extends upwardly from a portion of the left bottom longitudinal member 2420 proximate to the rear portion 2500 towards the top section 2200, and a right rear upwardly extending member 2455 extends upwardly from a portion of the right bottom longitudinal member 2425 proximate to the rear portion 2500 towards the top section 2200.

The middle portion 2400, the front portion 2300 and/or the rear portion 2500 comprise attachment means and/or attachment assemblies for attaching the structural battery assembly 2410 thereto, thereby providing a connection between the front portion 2300 and the rear portion 2500.

A left front attachment member 2460 and a right front attachment member 2465 extend from the front portion 2300 towards the rear portion 2500. A left rear attachment member 2470 and a right rear attachment member 2475 extend from the rear portion 2500 towards the front portion 2300. The attachment members 2460, 2465, 2470, 2475 extend in a substantially longitudinal direction.

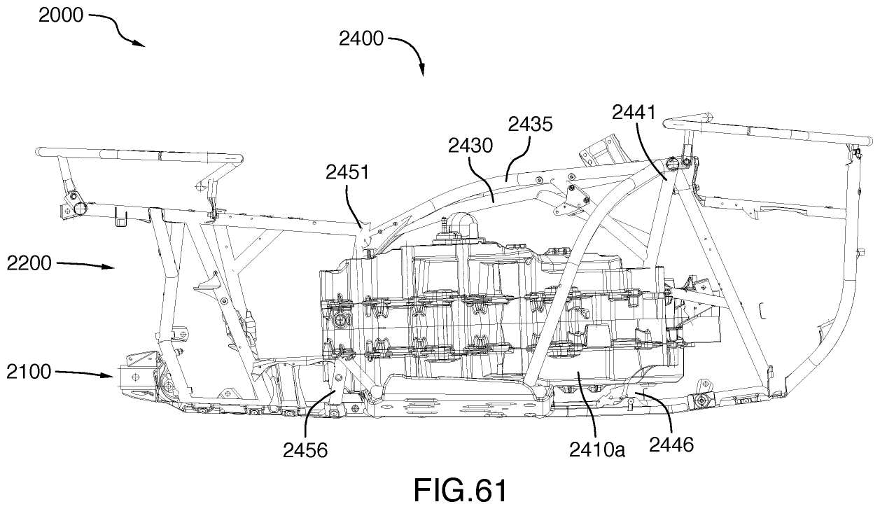

Referring now to FIG. 61, an exemplary middle portion 2400 comprising a structural battery assembly 2410a providing a structural connection between the bottom section 2100 and the top section 2200 is presented. In general, a structural battery assembly 2410a may be provided on at least one vertically extending frame member to provide a structural connection between the bottom section 2100 and the top section 2200.

The structural battery assembly 2410a may be attached to one or more upwardly extending members 2441, 2446, 2451, 2456, providing a structural connection therebetween and thus providing a structural connection between the bottom section 2100 and the top section 2200. A structural connection between the front portion 2300 and the rear portion 2500 is additionally provided by bottom longitudinal members as described above, and by left and right top longitudinal members 2430, 2435. While upwardly extending members 2441, 2446, 2451, 2456 are shown on FIG. 61 as being generally located on a right side of the frame 2000, it is understood that equivalent members may extend from equivalent components on a left side of the frame 2000, and that other arrangements of the upwardly extending members are possible.

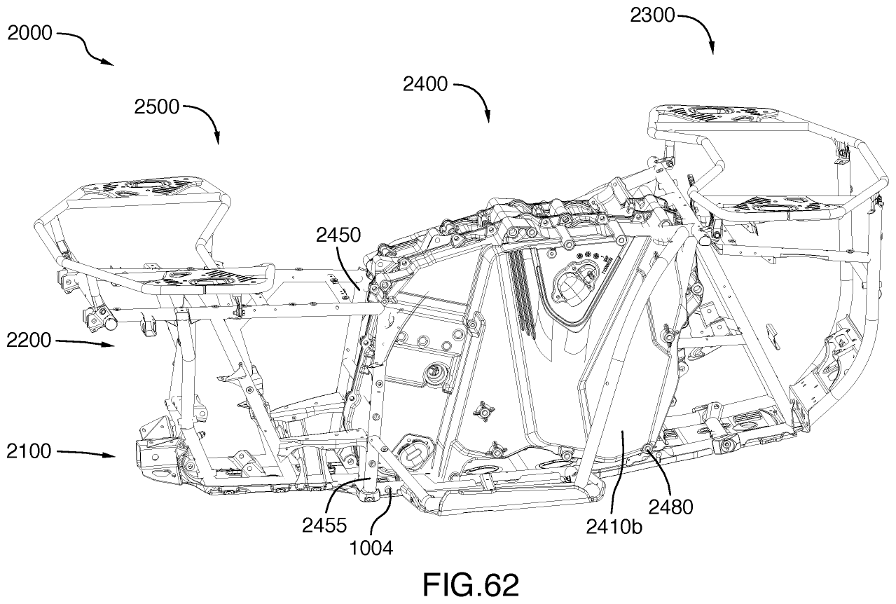

Referring now to FIG. 62, a structural battery assembly 2410b provides substantially the sole structural connection between the bottom section 2100 and the top section 2200 in the middle portion 2400, as well as providing substantially the sole structural connection between the front portion 2300 and the rear portion 2500. Accordingly, the frame 2000 comprises a middle portion 2400 wherein the bottom section 2100 and the top section 2200 are structurally connected by means of a structural battery assembly 2410b, the structural battery assembly 2410b extending between the front portion 2300 and the rear portion 2500, being attached to the bottom section 2100 and the top section 2200 by brackets 2480 or other appropriate attachment, securing and/or fastening means. In FIG. 62, the structural battery assembly 2410b replaces the structural connection provided by left and right front upwardly extending members 2440, 2445, and by left and right top longitudinal members 2430, 2435 shown in FIG. 61. Bottom longitudinal members such as lower tubes as previously described (right lower tube 1004 shown in FIG. 62) provide a structural connection in the bottom section 2100. The structural battery assembly 2410b is configured to be secured to left and right rear upwardly extending members 2450, 2455 and to the bottom longitudinal members.

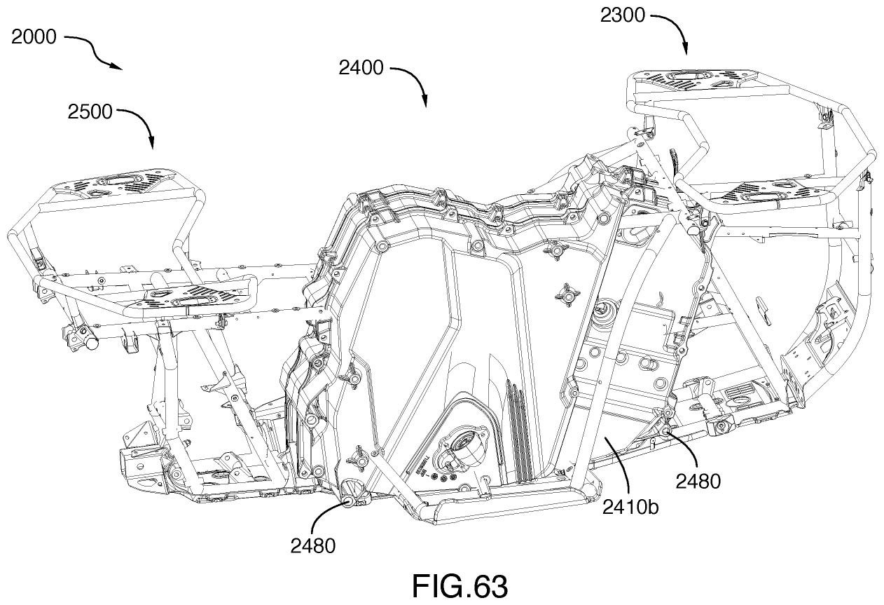

Referring now to FIG. 63, the structural battery assembly 2410b is the only structural means providing a structural connection between the front portion 2300 and the rear portion 2500. Accordingly, the middle portion 2400 does not comprise members, tubes, beams or other structural elements providing a structural connection between the front portion 2300 and the rear portion 2500. The structural battery assembly 2410b is configured to be attached directly to the rear portion 2500 and to the front portion 2300, for example by means of one or more brackets 2480.

It is understood that other combinations for providing structural connections between the bottom section 2100, the top section 2200, the front portion 2300 and the rear portion 2500 are possible.

While the embodiments shown in FIGS. 60 to 63 have been described with reference to a four-wheel arrangement, the frame assembly 2000 may be configured to have different wheel arrangements mounted thereto, for example an arrangement comprising two wheels mounted to the front portion and one wheel mounted to the rear portion, or vice-versa. Other suitable wheel arrangements, including but not limited to the front and/or rear portion comprising more than two wheels are possible.

While FIG. 60 shows attachment members 2460, 2465, 2470 and 2475 extending in a substantially longitudinal direction, it is understood that the attachment members for securing the structural battery assembly to the frame assembly 2000 may also extend in other directions for attaching the structural battery assembly 2410, 2410a, 2410b to the frame assembly 2000. For example, the attachment members may extend diagonally, including extending from the bottom section 2100 towards the top section 2200, or vice versa. The frame assembly 2000 may comprise any number of attachment members and/or upwardly extending members for securing the structural battery assembly 2410, 2410a, 2410b thereto. Other configurations of attachment means and assemblies are possible.

The attachment members may be comprised in the top section 2200, in the bottom section 2100, in the front portion 2300 and/or in the rear portion 2500 as well.

It is understood that the middle portion 2400 may comprise upper longitudinal members extending between the front portion 2300 and the rear portion 2500. For example, the structural battery assembly 2410 may be configured to provide a structural connection within the bottom section 2100 only, thus a middle portion 2400 may comprise one or more structural connections in the top section 2200 between the front portion 2300 and the rear portion 2500. Other configurations for providing a structural connection between the front portion 2300 and the rear portion 2500 by means of a structural battery assembly 2410 are possible.

In addition to being configured for receiving at least a portion of loads from one of a front wheel, a rear wheel, the front portion 2300, the middle portion 2400 and the rear portion 2500, the structural battery assembly 2410, 2410a, 2410b may be further configured to receive at least a portion of loads from one or more elements of the off-road vehicle 10, including but not limited to one or more of suspensions, skid plates, cooling plates, seat mounting brackets, seats, footrests and cargo storage racks. It is understood that the loads comprise both loads arising from ordinary and/or routine use and/or management of an off-road vehicle, for example road vibrations, shocks due to transportation and loads due to off-road use, as well as loads placing greater stress on one or more of the components of the off-road vehicle 10, for example shocks from a collision and/or an impact with an object or an animal.

The off-road vehicle 10 may be provided as a kit for assembling by a user. For example, the kit may comprise portions of the frame having components of the off-road vehicle preassembled therein and the structural battery assembly. In a non-limiting example, the kit comprises a front portion having at least a front final drive unit, a rear portion having at least an electric motor and a rear final drive unit, a driveshaft, and a structural battery assembly configured to replace a middle portion of the off-road vehicle by providing a structural connection between the front portion and the rear portion. Further off-road vehicle components such as steering assemblies, wheels, fairings and others may be provided separately or together with the kit components described above.

The battery assemblies 1410, 1410a previously described may be adapted to serve as a structural battery assembly and may, accordingly, also be provided as part of a kit.

A structural link between portions and/or features of an off-road vehicle by means of a battery simplifies frame design. Accordingly, the overall volume available for a battery assembly is increased and the need for additional battery mounting brackets extending from the frame is reduced.

The robustness of a battery housing and a frame for an off-road vehicle achieve a synergistic strengthening effect without compromising user safety.

An overall reduction in the number of frame components reduces frame weight and frame costs.

The example embodiments presented above are not to be construed as limiting the scope of the present disclosure. Various modifications to the illustrated and described embodiments will be apparent to the skilled person, and the generic principles herein may be applied to other embodiments and applications without departing from the present teachings.

1. A frame assembly for an off-road vehicle having at least one front wheel and at least one rear wheel, the frame assembly comprising:
a bottom section;
a top section;
a front portion for supporting the at least one front wheel;
a rear portion for supporting the at least one rear wheel; and
a middle portion connecting the front portion and the rear portion, the middle portion comprising a structural battery assembly, the structural battery assembly being configured for receiving loads from at least one of the front portion, the rear portion and the middle portion.

2. The frame assembly of claim 1, wherein the battery assembly provides a connection between the front portion and the rear portion of the frame assembly.

3. The frame assembly of claim 2, further comprising:
at least one front attachment member extending from the front portion towards the rear portion and connecting a front end of the structural battery assembly; and
at least one rear attachment member extending from the rear portion of the frame assembly towards the front portion and connecting a rear end of the structural battery assembly.

4. The frame assembly of claim 3, wherein the at least one front attachment member is part of the front portion.

5. The frame assembly of claim 3, wherein the at least one front attachment member is part of the middle portion.

6. The frame assembly of claim 3, wherein the at least one rear attachment member is part of the rear portion.

7. The frame assembly of claim 3, wherein the at least one rear attachment member is part of the middle portion.

8. The frame assembly of claim 3, wherein the frame assembly comprises a front end and a rear end and a longitudinal axis between the front end and the rear end, and wherein at least one of the at least one front attachment member and the at least one rear attachment member extends substantially along the longitudinal axis.

9. The frame assembly of claim 3, wherein the at least one front and rear attachment members are located in the top section of the frame assembly.

10. The frame assembly of claim 3, wherein the at least one front and rear attachment members are located in the bottom section of the frame assembly.

11. The frame assembly of claim 10, further comprising at least one longitudinal member for directly connecting the front portion of the frame assembly to the rear portion.

12. The frame assembly of claim 11, wherein the at least one longitudinal member extends below the battery assembly to connect the front portion of the frame assembly to the rear portion.

13. The frame assembly of claim 11, wherein the at least one longitudinal member extends above the battery assembly to connect the front portion of the frame assembly to the rear portion.

14. The frame assembly of claim 13, wherein the structural battery assembly provides a connection between the bottom frame section and the top frame section.

15. The frame assembly of claim 14, wherein the front portion of the frame assembly comprises at least one front vertical frame member extending between the bottom section and the top section, and wherein the battery assembly is provided on the at least one front vertical frame member to provide a connection between the bottom section and the top section.

16. The frame assembly of claim 15, wherein the rear portion of the frame assembly comprises at least one rear vertical frame member extending between the bottom section and the top section, and wherein the battery assembly is provided on the at least one rear vertical frame member to provide connection between the bottom section and the top section.

17. The frame assembly of claim 16, wherein the frame assembly further comprises a skid plate mounted to at least one of the front portion, the middle portion and the rear portion, and wherein the battery assembly is configured for receiving loads from the skid plate.

18. The frame assembly of claim 17, wherein the battery assembly is located above the skid plate.

19. The frame assembly of claim 17, wherein the frame assembly further comprises a rack mounted to at least one of the front portion, the middle portion and the rear portion, and wherein the battery is configured for receiving loads from the rack.

20. The frame assembly of claim 19, wherein the rack comprises a cargo storage rack.

21. The frame assembly of claim 20, further comprising at least one seat mounting bracket provided on at least one of the middle portion and the rear portion for mounting a seat to the frame assembly, and wherein the battery is configured for receiving loads from the seat mounting bracket.

22. The frame assembly of claim 21, wherein the seat is a straddle seat.

23. The frame assembly of claim 22, wherein the battery assembly comprises a battery housing, the battery housing being configured for receiving at least of portion of the loads from the front portion, the rear portion and the middle portion.

24. The frame assembly of claim 23, wherein the battery assembly further comprises a battery pack housed in the battery housing.

25. The frame assembly of claim 24, wherein loads from the front section comprise loads received from at least one of the at least front wheel, a front suspension and an impact on the front portion of the frame assembly.

26. The frame assembly of claim 25, wherein loads from the rear section comprise loads received from at least one of the at least one rear wheel, a rear suspension and an impact on the rear portion of the frame assembly.

27. The frame assembly of claim 26, wherein the structural battery assembly is configured for receiving loads from at least two of the front section, the middle section, the rear section, the skid plate, the rack and the at least one seat mounting bracket.

28. The frame assembly of claim 27, wherein the middle portion is comprised substantially entirely of the battery assembly.

29. An off-road vehicle comprising a frame assembly as defined in claim 28.

30. The off-road vehicle of claim 29, wherein the off-road vehicle comprises an all-electric off-road vehicle or a hybrid electric off-road vehicle.

31. The off-road vehicle of claim 30, wherein the off-road vehicle further comprises:
an electric motor electrically connected to the battery assembly; and
a transmission assembly operatively coupling the electric motor to at least one of the at least one front wheel and the at least one rear wheel, the transmission assembly comprising a driveshaft.

32. The off-road vehicle of claim 31, wherein the battery assembly is configured to allow the passage of the driveshaft towards the front portion or the rear portion to connect to the at least one front wheel or the at least one rear wheel.

33. The off-road vehicle of claim 32, wherein the battery assembly is configured to allow the passage of the driveshaft towards the front portion or the rear portion above the battery assembly.

34. The off-road vehicle of claim 32, wherein the battery assembly is configured to allow the passage of the driveshaft towards the front portion or the rear portion below the battery assembly.

35. The off-road vehicle of claim 32, wherein the battery assembly comprises a channel defined therein, the channel allowing the passage of the driveshaft through the battery assembly, towards the front portion or the rear portion.

36. A method for assembling an off-road vehicle comprising a frame assembly, at least one front wheel, at least one rear wheel, and an electric motor mounted to the frame assembly and operatively coupled to at least one of the at least one front wheel and the at least one rear wheel, the method comprising:
providing the frame assembly in accordance with claim 1;
providing a structural battery assembly;
installing the structural battery assembly to the frame assembly; and
connecting the structural battery assembly and the electric motor using a phase cable.

37. The method of claim 36, further comprising the steps of installing the at least one front wheel and the at least one rear wheel.

38. The method of claim 37, wherein the steps of installing the at least one front wheel and the at least one rear wheel are carried out before or after installing the battery to the frame assembly.
